(19) United States
(12) Patent Application Publication
(10) Pub. No.: US 2023/0212445 A1
(43) Pub. Date: Jul. 6, 2023

(54) WATERPROOF ADHESIVE COMPOSITIONS

(71) Applicant: Carroll Benford Dickens, Santa Ana, CA (US)

(72) Inventor: Carroll Benford Dickens, Santa Ana, CA (US)

(21) Appl. No.: 18/182,059

(22) Filed: Mar. 10, 2023

Related U.S. Application Data
(63) Continuation-in-part of application No. 17/061,293, filed on Oct. 1, 2020.
Application No. 17/061,293 is a continuation-in-part of application No. 16/856,900, filed on Apr. 23, 2020, now abandoned.
Application No. 16/856,900 is a continuation-in-part of application No. 16/156,809, filed on Oct. 10, 2018, now Pat. No. 11,261,347.
Application No. 16/856,900 is a continuation-in-part of application No. 15/982,671, filed on May 17, 2018, now abandoned.
Application No. 15/982,671 is a continuation-in-part of application No. 15/583,344, filed on May 1, 2017, now Pat. No. 10,308,847.
Application No. 15/583,344 is a continuation-in-part of application No. 15/043,075, filed on Feb. 12, 2016, now Pat. No. 9,822,288.
Application No. 15/043,075 is a continuation-in-part of application No. 14/376,112, filed on Jul. 31, 2014, now abandoned.
Application No. 14/376,112 is a continuation-in-part of application No. 13/365,850, filed on Feb. 3, 2012, now Pat. No. 9,068,103.
Application No. 15/982,671 is a continuation-in-part of application No. 15/403,522, filed on Jan. 11, 2017, now abandoned.
Application No. 16/856,900 is a continuation-in-part of application No. 16/226,000, filed on Dec. 19, 2018, now abandoned.
Application No. 16/226,000 is a continuation-in-part of application No. 15/243,245, filed on Aug. 22, 2016, now Pat. No. 10,161,140.
Application No. 15/243,245 is a continuation-in-part of application No. 14/520,712, filed on Oct. 22, 2014, now abandoned.
Application No. 14/520,712 is a continuation-in-part of application No. 15/043,075, filed on Feb. 12, 2016, now Pat. No. 9,822,288.
Application No. 15/043,075 is a continuation-in-part of application No. 14/376,112, filed on Jul. 31, 2014, now abandoned.
Application No. 14/376,112 is a continuation-in-part of application No. 13/365,850, filed on Feb. 3, 2012, now Pat. No. 9,068,103.
(60) Provisional application No. 62/856,359, filed on Jun. 3, 2019.
(60) Provisional application No. 62/837,488, filed on Apr. 23, 2019.
(60) Provisional application No. 62/570,843, filed on Oct. 11, 2017.
(60) Provisional application No. 61/439,271, filed on Feb. 3, 2011.
(60) Provisional application No. 62/278,091, filed on Jan. 13, 2016.
(60) Provisional application No. 61/439,271, filed on Feb. 3, 2011.

(51) Int. Cl. C09J 183/04; C09J 11/06; C09J 5/04

(52) U.S. Cl. CPC C09J 183/04; C09J 11/06; C09J 5/04; C09J 2483/00

(57) ABSTRACT

Waterproof urethane-based adhesive compositions for flooring applications. Silane is reacted with a prepolymer to at least partially end-cap the prepolymer. A reinforcing extender, a thixotropic agent, a magnetic agent, a first catalyst, and methylethylketoximino (MEKO) silane are also added to the composition to form the deactivated adhesive mixture. Prior to coating a substrate with the adhesive, a second catalyst is added to the adhesive mixture. The second catalyst speeds up the curing time and improves the shelf life of the moisture cure adhesive. The adhesive is cured to a final product that is waterproof, hydrolytically stable, and pH resistant.

### CROSS REFERENCE

This application is a continuation-in-part and claims benefit of U.S. patent application Ser. No. 17/061,293 filed Oct. 1, 2020, which is a continuation-in-part and claims benefit of U.S. patent application Ser. No. 16/856,900 filed Apr. 23, 2020, which claims benefit of U.S. Provisional Patent Application No. 62/856,359 filed Jun. 3, 2019 and U.S. Provisional Patent Application No. 62/837,488 filed Apr. 23, 2019, the specifications of which are incorporated herein in their entirety by reference.

U.S. patent application Ser. No. 16/856,900 is also a continuation-in-part and claims benefit of U.S. patent application Ser. No. 16/156,809 filed Oct. 10, 2018, now U.S. Pat. No. 11,261,347, which claims benefit of U.S. Provisional Patent Application No. 62/570,843 filed Oct. 11, 2017, the specifications of which are incorporated herein in their entirety by reference.

U.S. patent application Ser. No. 16/856,900 is also a continuation-in-part and claims benefit of U.S. patent application Ser. No. 15/982,671 filed May 17, 2018, which is a continuation-in-part and claims benefit of U.S. patent application Ser. No. 15/583,344 filed May 1, 2017, now U.S. Pat. No. 10,308,847, which is a continuation-in-part and claims benefit of U.S. patent application Ser. No. 15/043,075 filed Feb. 12, 2016, now U.S. Pat. No. 9,822,288, which is a continuation-in-part and claims benefit of U.S. patent application Ser. No. 14/376,112 filed Jul. 31, 2014, which is a 371 of PCT/US13/24314 filed Feb. 1, 2013, which claims benefit of U.S. patent application Ser. No. 13/365,850 filed Feb. 3, 2012, now U.S. Pat. No. 9,068,103, which is a non-provisional and claims benefit of U.S. Provisional Patent Application No. 61/439,271, filed Feb. 3, 2011, the specification(s) of which is/are incorporated herein in their entirety by reference.

U.S. patent application Ser. No. 15/982,671 is also a continuation-in-part and claims benefit of U.S. patent application Ser. No. 15/403,522, filed Jan. 11, 2017, which is a non-provisional and claims benefit of U.S. Provisional Application No. 62/278,091, filed Jan. 13, 2016, the specification(s) of which is/are incorporated herein in their entirety by reference.

U.S. patent application Ser. No. 16/856,900 is also a continuation-in-part and claims benefit of U.S. patent application Ser. No. 16/226,000, filed Dec. 19, 2018, which is a continuation-in-part and claims benefit of U.S. patent application Ser. No.15/243,245, filed Aug. 22, 2016 now U.S. Pat. No. 10,161,140, which is a continuation-in-part and claims benefit of U.S. patent application Ser. No. 14/520,712, filed Oct. 22, 2014, the specification(s) of which is/are incorporated herein in their entirety by reference.

U.S. patent application Ser. No. 15/243,245 is also a continuation-in-part and claims benefit of U.S. patent application Ser. No. 15/043,075, filed Feb. 12, 2016, now U.S. Pat. No. 9,822,288, which is a continuation-in-part and claims benefit of U.S. patent application Ser. No. 14/376,112, filed Jul. 31, 2014, which is a 371 of PCT/US13/24314, filed Feb. 1, 2013, which claims benefit of U.S. patent application Ser. No. 13/365,850, filed Feb. 3, 2012, now U.S. Pat. No. 9,068,103, which is a non-provisional and claims benefit of U.S. Provisional Patent Application No. 61/439,271, filed Feb. 3, 2011, the specification(s) of which is/are incorporated herein in their entirety by reference.

### FIELD OF THE INVENTION

The present invention is directed to a waterproof adhesive, e.g., a formulated silane end-capped adhesive. The coating may be used, for example, to provide a concrete substrate with an adhesive to which flooring materials may be attached.

### BACKGROUND OF THE INVENTION

Concrete is a common and popular composite material used for constructing structures. It is used to make roads, buildings, walls, and floors. Concrete may be composed of water, granular solids, and binders, along with other materials, that are mixed together to form a highly viscous fluid that cures and dries into a hard, rigid mass. When used in flooring applications, i.e. building foundations, a flooring material may be applied onto the concrete surface. Some examples of flooring material are chemical finishes, wood, tile, and flooring covers such as carpet and vinyl.

One of the most common problems in the floor-covering industry continues to be floor-covering failures related to excessive moisture and pH of concrete floor slabs. When concrete slabs are not given the proper time or proper conditions to dry, excessive water or vapor can be present inside the porous concrete slab surface contributing to water or vapor movement. All flooring categories are affected, including resilient flooring, carpet tiles, carpet, wood flooring, coatings and more. The problems for floor damage range from cupping, buckling, blistering and adhesive failure to discoloration and mold growth. This resulting failure is characterized by a loss of the flooring adhesive. Adhesives are used in a number of applications for holding, protecting, and sealing purposes. In the flooring industry, adhesives are used to bond flooring materials to rigid substrates, such as concrete. During the early part of the 1990s, the flooring industry moved from solvent-born adhesives to aqueous or water-born formulations. Subsequently, it became evident that the water-born formulations were sensitive to elevated concrete moisture and pH. For example, problems from excessive moisture and high pH attack can cause adhesives to hydrolyze and chemically break-down, and eventually, the adhesive will begin to ooze from the joints. Loss of bond strength results from the hydrolyzation of the adhesive, and mold contamination can occur, which can eventually lead to strong odor and poor indoor air-quality. In cases where floors are subjected to elevated moisture from maintenance, flooding, or relatively high humidity, the failure of these water-born formulations can lead to extensive and costly repairs. For instance, it has been estimated that concrete-slab, moisture-related floor-covering failures cost retailers, building owners and contractors over $1 billion every year.

The current standard industry practice to combat the issue of pH catalyzed moisture degradation in adhesives is to apply a moisture barrier coating with near zero permeability to the concrete surface in order to negate the effects of alkaline moisture attack and protect installation adhesives from failure. There are currently two types of polymeric products that are used to restrict moisture vapor movement from the concrete surface such as i) a water-based polymeric product and ii) an epoxy-based product.

The water-based polymeric product contains an acrylic or acrylic copolymer backbone that is applied to the surface of the concrete where it forms a topical film, like paint. This film has limited porosity and functions to reduce the moisture vapor emissions from the concrete surface to a very minimal degree. This water-based polymeric product is not intrinsic in nature and it does not penetrate inside the concrete material to react with the concrete substrate. The water based polymeric product requires a coalescing solvent to form a cross linked polymeric material. Therefore, the water based polymeric product is typically not VOC exempt.

In many commercial formulations of thermoplastic and thermosetting latex (a common term for aqueous polymers referring to their resemblance to natural liquid rubber) paints, the most common functional groups introduced are carboxylic acids and hydroxyl groups. Carboxylic acid groups are usually incorporated in the polymer backbone via co-polymerization of acrylic or methacrylic acids. Carboxyl groups usually improve mechanical and shear stability, film hardness and adhesion to substrates. Cross-linking is possible ionically and/or covalently. Modern acrylic resin polymers and their copolymer adjuncts are carboxylated to enable ionic/covalent cross-links to form upon drying. As the formulated coating dries, water is evaporated and the carboxylation reaction propagates, enabling cross-link formation. This chemical reaction is not in equilibria or is reversible only through degradation. The polymer crosslinks result in a multiplier effect on the molecular weight or mass, developing a crosslink lattice that decreases the volume of the coating product and increases the polymer/film (crystalline) density. Upon cure, the dried coating material has reduced water solubility and when formulated correctly can exhibit water resistant properties. However, these coatings are also susceptible to alkaline attack, and can hydrolyze or otherwise liquefy. These coatings are topical in nature and are not an intrinsic part of the near-surface concrete.

The epoxy-based product forms a topical coating when applied to a concrete substrate that is totally occlusive and virtually impermeable to concrete moisture vapor. The most common and important class of epoxy resins are formed from the reaction of epichlorohydrin with bisphenol A to form diglycidyl ethers of bisphenol A (BPA). As such said epoxy coatings are supplied as a two-part material: Part A is the BPA and Part B is the supplied hardener often referred to as the reactive amine. The epoxy-based product is not intrinsic in nature or self-priming as is the present invention. The epoxy forms a topical coating that is similar to a solid, continuous sheet of glass-like material. When applied to the concrete substrate, the concrete surface is left completely sealed and unbreathable. Due to this smooth, hardened low energy surface, epoxy-based coatings require surface modification such as surface abrasion or the application of an additional primer in order to promote inter-coat adhesion with secondary materials. Epoxy coatings can become problematic in their performance under certain conditions in combination with concrete. The inherent nature of epoxy coatings and their low permeance and structural, highly porosity of cured concrete can lead to osmotic conditions associated with alkaline surface reactions. The result is blistering and delamination of the occlusive epoxy film.

Hence, there is also a need for improved moisture barriers that can be used in conjunction with adhesives.

Flooring systems have been developed which include a magnetic sheet or underlayment to which flooring materials are attached magnetically. These systems use no adhesive between the magnetized sheet and the flooring material but instead rely on the magnetic force to hold the flooring material in place. One advantage of this approach is that the flooring material can easily be replaced by peeling the old flooring material off the magnetized sheet and sticking a new flooring material to the magnetized sheet without any additional preparation. Many different types of magnetic flooring materials can be designed to interface with the magnetic underlayment, so the same underlayment could be used to install various flooring materials such as laminate flooring, tiles, carpet, or wood planks. This simplicity allows for a saving of labor costs when installing or replacing the flooring material. However, because the system uses a separate magnetic sheet and subfloor, both the subfloor and the sheet must be correctly installed before the flooring material may be affixed in place. Installing the sheet over the subfloor may be time consuming as it must be cut to the appropriate size and shape, the seams must be aligned, and wrinkles must be avoided. Hence there is a need for a subfloor coating which is magnetic and allows for installation of interchangeable magnetic flooring materials.

In some embodiments, the present invention features a novel coating material that possesses alkaline and waterproof properties in order to mitigate the problems caused by high moisture and alkalinity, as well as exhibiting pressure sensitive properties, electrostatic dissipative, magnetic and acoustic properties. In some embodiments, the present invention may be used in flooring or wall covering applications to provide for a strong, durable and permanent adhesion that allows for facile installation of flooring materials.

In other embodiments, the present invention features a polymer composition for suppressing moisture vapor emissions in a concrete substrate by penetrating and polymerizing within the surface of the concrete substrate to form a densified concrete and plastic matrix. This matrix effectively reduces the porosity of the concrete surface. The polymer material is self-priming and intrinsic in nature and does not require a coalescing solvent for film formation.

### SUMMARY OF THE INVENTION

It is an objective of the present invention to provide a waterproof urethane-based adhesive with pressure sensitive, electrostatic dissipative, and sound reducing abilities. Embodiments of the invention are given in the dependent claims. Embodiments of the present invention can be freely combined with each other if they are not mutually exclusive.

In some aspects, the present invention features a magnetic waterproof coating composition comprising a cured product comprising a urethane component, a first silane component, a second silane component comprising a silane end-capped polymer component comprising a first silane and a urethane component, a second silane comprising methylethylketoximino (MEKO) silane, a reinforcing extender, a magnetic agent, and a thixotropic agent. Preferably, the coating composition is pressure-sensitive, magnetic, waterproof, hydrolytically stable, and pH-resistant. More preferably, when the coating composition is applied to a substrate, the coating composition has a tack-free time of at least about 90 minutes. Furthermore, the cured product has a sound transmission class (STC) rating of 62 and an impact insulation class (IIC) rating of 57.

In one embodiment, the first silane component may comprise an amino-functional alkoxysilane polymer having terminal silanol groups. The urethane component may have an average NCO content of about 7 to 23%. The urethane component may comprise one or both of: i) a slow-cure urethane having a functionality (Fn) of about 2.5 to 2.55 and an NCO content of about 15 to 23%, or ii) a flexible binder urethane having a functionality (Fn) of about 2 and an NCO content of about 7 to 10%. In some embodiments, the MEKO silane may be according to the formula:

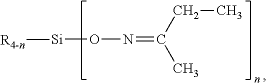

where n can range from 1 to 4 and R may be an alkyl, an alkene, or aryl group.

In another embodiment, the present invention features a method of producing a curable pressure sensitive, magnetic, waterproof coating mixture. The method may include providing a urethane component, providing a first silane component, providing a reinforcing extender, providing a magnetic agent, providing a thixotropic agent, mixing the urethane component, the first silane component, the reinforcing extender, the magnetic agent and the thixotropic agent to form a dispersion, adding a second silane component comprising a methylethylketoximino (MEKO) silane to the dispersion, and mixing the second silane component and the dispersion to form the coating mixture. Without wishing to limit the invention to a particular theory or mechanism, the method can be effective for producing a coating mixture that, when applied to substrate, has a tack-free time of at least about 90 minutes. Further still, the coating mixture can be pressure—sensitive, waterproof, hydrolytically stable, and pH-resistant.

In other aspects, the present invention features a polymeric matrix coating composition comprising a cured product of a silane end-capped polymer component comprising a first silane and a urethane component, a reinforcing extender, a magnetic agent, and a thixotropic agent. Preferably, the cured product has a Sound Transmission Class (STC) rating of 62 and an Impact Insulation Class (IIC) rating of 57. More preferably, the coating composition is magnetic, waterproof, hydrolytically stable, and pH-resistant.

In non-limiting embodiments, the composition may comprise about 15-85 wt % of the silane end-capped polymer component, about 3-7 wt % of the reinforcing extender, about 0.1-20 wt % of the magnetic agent, and about 2-5 wt % of the thixotropic agent. In some embodiments, the composition may comprise about 10-15 wt % of the magnetic agent. In some embodiments, the first silane component may comprise an amino-functional alkoxysilane polymer having terminal silanol groups. In some other embodiments, the urethane component may comprise one or both of: i) a slow-cure urethane having a functionality (Fn) of about 2.5 to 2.55 and an NCO content of about 15 to 23%, or ii) a flexible binder urethane having a functionality (Fn) of about 2 and an NCO content of about 7 to 10%. In still other embodiments, the urethane component has an average NCO content of about 7 to 23%. In further embodiments, the composition may further comprise a second silane comprising a methylethylketoximino (MEKO) silane according to the formula:

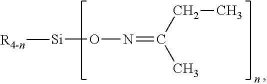

where n can range from 1 to 4, and R may be an alkyl, an alkene, or aryl group.

In accordance with previous embodiments, the reinforcing extender may be hydrophobically modified. Alternatively, or in addition, the thixotropic agent may be hydrophobically modified.

Consistent with previous embodiments, the coating composition may further comprise about 25-55 wt % of a polyol component having an average molecular weight of at least about 4,000 g/mol. In some embodiments, the coating composition may further comprise about 5-10 wt % of an aliphatic quencher. In other embodiments, the coating composition may further comprise about 2-10 wt % of a tackifier.

Consistent with previous embodiments, the coating composition may further comprise carbon nanofibers effective for increasing electrical conductivity of the coating composition. The carbon nanofiber can have a fiber diameter of about 120 to 160 nm. In some embodiments, the carbon nanofibers have a dispersive surface energy of about 120 to 140 mJ/m². In still other embodiments, the coating composition may further comprise an inherently static dissipative (IDP) component effective for decreasing surface resistance of the coating composition. The IDP component can have a surface resistivity of about 10⁷ to 10¹⁰ Ω/sq. In some embodiments, the IDP component may be polypropylene, polystyrene, polyethylene, or acrylic polymers.

In some embodiments, the MEKO silane can impart pressure sensitivity to the composition. Thus, coating curing may be activated when pressure is applied to the coating. Examples of the MEKO silane include, but are not limited to, methyl tris(MEKO)silane, phenyl tris(MEKO)silane, vinyl tris(MEKO)silane, tetrakis(MEKO)-silane, dimethyl bis(MEKO)silane, or a combination thereof.

One of the unique inventive technical features of the present invention is that the use of MEKO silanes in the present coating composition surprisingly resulted in a sigmoidal cure curve with a lag phase spanning about 90 minutes, as shown in FIG. 2A. This delayed cure transition is unlike the typical urethane adhesives that follow a more linear rate of cure at least during the 1^{st} hour of application. Without wishing to limit the invention to any theory or mechanism, it is believed that the technical feature of the present invention advantageously suppresses the cure rate of the coating, i.e. solidification of the coating, thereby allowing more time for a user to properly install the coating while the coating is still wet or tacky during this lag phase. The cure rate of the coating then surprisingly increases after this lag phase, and transitions to a more conventional urethane curative state. None of the presently known prior references or work has the unique inventive technical feature of the present invention. Further still, one of ordinary skill in the art cannot predict or at once envisage that the coating composition of the present invention would yield the aforementioned features.

It is another objective of the present invention to provide a prepolymer composition that is designed to penetrate the porous concrete surface and initiate polymerization. The present composition is used to form, upon cure, a densified plastic/concrete matrix within the near-surface of the concrete substrate in order to reduce the porosity, restrict capillary activity and thereby reduce moisture vapor movement from the concrete surface.

In some aspects, the invention features a prepolymer composition for suppressing moisture vapor movement in a concrete substrate. In one embodiment, the polymer composition may comprise a polyisocyanate component, one or more thinning components, a wetting and leveling component, a tackifier, and a catalyst. Without wishing to limit the invention to a particular theory or mechanism, when the prepolymer composition is applied to a concrete surface of the concrete substrate, the prepolymer composition can penetrate and polymerize within the concrete surface of the concrete substrate to form a densified concrete and plastic matrix. This extremely hard plastic matrix within the concrete substrate can have a hardness in Durometer type D scale of more than 95. The densified concrete and plastic matrix are effective to reduce a porosity of the concrete surface or near-surface region, thereby restricting movement of moisture vapor, which is disposed within the concrete substrate, to the concrete surface.

In some embodiments, the prepolymer composition uses polyisocyanates only, without the presence of any other oligomers for crosslinking. Short chain biuret and/or trimers resulting from the crosslinking of said polyisocyanates can develop high crosslink densities which attribute to the hardness of the material. The present invention does not form a topical film coating on concrete surfaces like water-based polymeric products, and the invention does not completely restrict moisture vapor movement from the concrete surface such as typical epoxy coatings. Instead, the presently claimed polymeric composition penetrates and reacts within the concrete substrate to form an extremely hard, densified plastic matrix which restricts the water vapor emission up to 80% from the concrete surface. Without wishing to limit the invention to a particular theory or mechanism, the present invention can effectively prevent blistering and delamination due to the fact that the invention is neither occlusive nor a localized topical coating. The invention is penetrating, intrinsically reactive, and highly crosslinked, and forms a densified concrete and plastic matrix within the body of the concrete near-surface region, which functions to reduce moisture vapor permeability and acts as a permanent concrete modifying fixture.

In some embodiments, any of the compositions described herein may comprise a magnetic coating. In preferred embodiments, the magnetic coating is waterproof, pH resistant, permeant, and cures in less than three hours. Furthermore, the magnetic coating may allow for attachment of materials such as flooring materials or wall covering materials without an adhesive. In some embodiments, the coating may have a lower viscosity than the corresponding adhesive composition. In preferred embodiments, the magnetic coatings are waterproof, pH resistant, and permanent, and cure in less than 3 hours. As a non-limiting example, these magnetic coatings may be used as part of an interchangeable flooring system in which a concrete surface is coated with the magnetic coating, and various flooring materials may be simply applied to the magnetic coating after it is cured, and held in place by magnetic force.

One of the unique and inventive technical features of the present invention is the deactivated moisture cure adhesive and a separate catalyst. The catalyst is kept separate from the deactivated adhesive composition until a substrate is ready to be coated with the adhesive. This greatly improves the shelf life of the deactivated adhesive composition. Typically, the shelf life of moisture cure adhesives is very short (about 3-6 months) because most containers cannot prevent moisture from contacting the adhesive. Furthermore, metal containers, which may prevent moisture from reaching the adhesive, are very expensive to be used in storing adhesives, and are therefore not economically feasible. With the present invention, the shelf life of the adhesive is improved from about 6 months to over a year, i.e. the shelf life of the adhesive is stable for 12 months or more depending upon storage conditions. When the substrate is ready to be coated with the adhesive, the catalyst is added to the deactivated adhesive, which speeds up the curing process of the adhesive from days to hours. None of the presently known prior references or work has the unique inventive technical feature of the present invention. Furthermore, the prior references teach away from the present invention. For example, urethane-based, moisture-cure adhesive compositions are sold as one part and the industry does not teach separating the catalyst from the adhesive. Thus, the present invention is entirely novel and inventive.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

The features and advantages of the present invention will become apparent from a consideration of the following detailed description presented in connection with the accompanying drawings in which:

FIG. 1A shows an illustration of a substrate with a magnetic coating attached via an adhesive bond, and a magnetic flooring material attached to the magnetic coating via a magnetic force.

FIG. 1B shows a non-limiting schematic of using a magnetic waterproof coating of the present invention to adhere flooring to a substrate such that it can be optionally removed without affecting the magnetic coating.

FIG. 2A shows adhesive curing as a function of time for a standard urethane formulation and the formulation of the present invention.

FIG. 2B shows a non-limiting schematic of preparing an adhesive of the present invention.

FIG. 3 shows a non-limiting schematic of using an adhesive of the present invention to bond substrates.

FIG. 4 shows the various types of commercial pressure sensitive adhesives.

FIG. 5 shows an exemplary process by which a polymer composition becomes a solid continuous film.

FIGS. 6A-6B show prepared sample concrete cores with a coating of the present invention, referred to as Aquaflex® MVS, applied thereon in accordance with ASTM C-856, Standard Practice for the Petrographic Examination of Hardened Concrete. The samples were analyzed under 200× magnification. UV illumination of the sample in FIG. 6B shows that the Aquaflex MVS penetrated about 2-5 Mils of the concrete paste layer.

FIG. 7A shows a waterproof adhesive coating kit of the present invention.

FIG. 7B is a non-limiting schematic of using the waterproof adhesive coating kit.

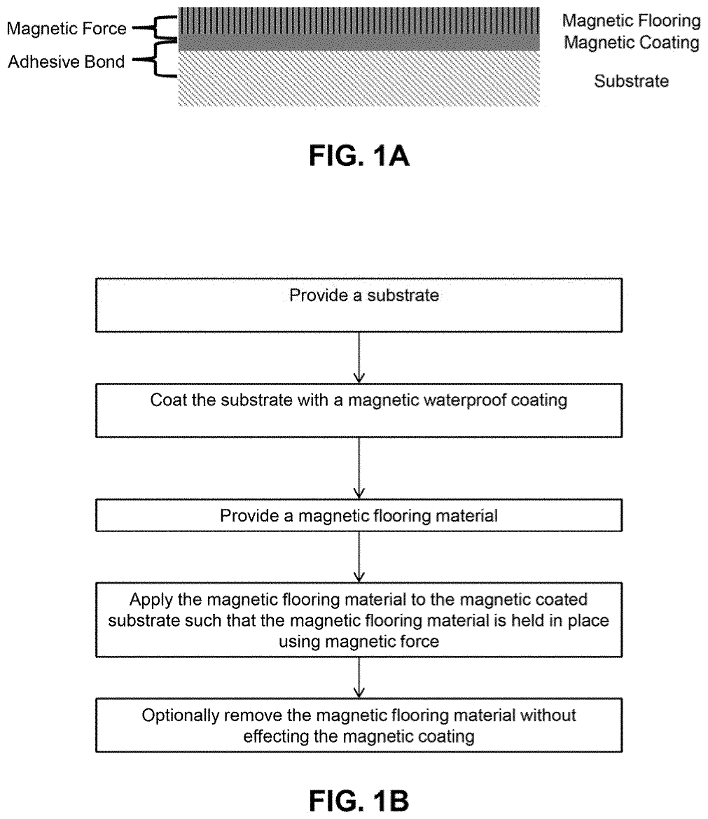

### DESCRIPTION OF PREFERRED EMBODIMENTS

Before the present invention is disclosed and described, it is to be understood that this invention is not limited to specific compositions, systems and methods, and as such, may vary. It is also to be understood that the terminology used herein is for the purpose of describing particular embodiments only and is not intended to be limiting.

As used herein, the term “tack-free” is defined as not being sticky. A material is said to be tack-free when it attains a sufficiently robust state to resist damage by contact or handling. This is a critical point to any cure, and the time to reach this point is an important control parameter. For open systems, such as sealants, coatings or free-rise foams, this is the tack-free time, defined as the period from the start of cure to a point when the material is sufficiently robust to resist damage by touch or settling dirt. In ad hoc testing, tack-free time can be determined as the point when the surface no longer feels sticky. In a more structured way, it can be determined by briefly pressing a polyethylene film against the surface and checking for any adhering material when the film is removed. A small metal weight, to provide a reproducible contact pressure, is commonly used in this test. Preferably, the coating material of the invention becomes tack-free in a period of about 90-120 minutes after application to the surface.

For proper bonding of concrete overlays and coatings, the surface should be given a correct concrete surface profile, or CSP. As known to one of ordinary skill in the art, the International Concrete Repair Institute has developed benchmark guidelines for CSP-a measure of the average distance from the peaks of the surface to the valleys. The CSP level can range from CSP 1 (nearly flat) to CSP 9 (very rough).

Concrete is plastic-like in a freshly mixed state and subsequently becomes hard, with considerable strength. This change in its physical properties is due to the chemical reaction between cement and water, a process known as hydration. Hydration involves chemical changes, not just a drying out of the material. The reaction is gradual, first causing stiffening of the concrete, and then development of strength, which continues for a very long time. The hardening process is not dependent on the concrete ‘drying out’, and it is normally important that the concrete is properly ‘cured’ to maintain the moisture in the concrete while the cement water reaction is active. As known to one of ordinary skill in the art, the term “hardened” when used in conjunction with a concrete substrate refers to the concrete substrate reaching a final set such that it has completely lost its plasticity and attained sufficient firmness to resist certain definite pressures. For example, a person can stand, or an object can be placed, on the hardened concrete substrate without leaving indentations on the surface of the concrete substrate. As defined in the American Concrete Institute (ACI) Manual of Concrete Practice, ACI 116R, “final set” is an empirical value indicating the time in hours and minutes required for the cement paste to stiffen sufficiently to resist to an established degree, for example, the penetration of a weighted test needle.

As used herein, alkali-resistance is defined as the ability to resist reactions with alkaline (pH>7) materials such as lime, cement, plaster, etc. As used herein, pH-resistance is defined as the ability to resist changes in pH.

As used herein, the term “waterproof” is defined as being impenetrable by water. This should not be confused or interchanged with the term “water-resistant”, which is defined as being penetrated by water over time and under high pressures. As used herein, the term “hydrolytically stable” is defined as resisting chemical decomposition in the presence of water.

As used herein, the terms “polymeric matrix coating”, “polymeric matrix coating composition”, “coating composition” and “coating mixture” can be used interchangeably, unless otherwise specified.

As used herein, the term “alkyl” refers to a monovalent group that is a radical of an alkane and having about 1 to 20 carbon atoms. The alkyl can be linear, branched, cyclic, or combinations. Examples of alkyl groups include, but are not limited to, methyl, ethyl, propyl, butyl, pentyl, hexyl, heptyl, octyl, etc.

As used herein, the term “alkene” refers to an unsaturated, aliphatic hydrocarbon group with one or more carbon-carbon double bonds. Examples of alkene groups include, but are not limited to, vinyls, allyls, isoprene, butenes, and hexenes.

As used herein, the term “aryl” refers to any functional group or substituent derived from an aromatic ring, usually an aromatic hydrocarbon. Examples of aryls groups include, but are not limited to, phenyls, tolyl, xylyl, and naphtyls.

As used herein, a durometer is a hardness test that measures the depth of an indentation in the material created by a given force on a standardized presser foot. This depth is dependent on the hardness of the material, its viscoelastic properties, the shape of the presser foot, and the duration of the test. ASTM D2240 durometers allow for a measurement of the initial hardness, or the indentation hardness after a given period of time. The final value of the hardness depends on the depth of the indenter after it has been applied for 15 seconds on the material. If the indenter penetrates 2.54 mm (0.100 inch) or more into the material, the durometer is 0 for that scale. If it does not penetrate at all, then the durometer is 100 for that scale. It is for this reason that multiple scales exist. A Durometer is a dimensionless quantity, and there is no simple relationship between a material's durometer in one scale, and its durometer in any other scale, or by any other hardness test. A durometer D scale, or Shore D scale, is typically used for hard rubber, thermoplastic, elastomers, harder plastics, and rigid thermoplastics.

### Waterproof Coatings

As used herein, the term “coating”, may be interchangeably referred to as “Aquaflex®”.

According to some embodiments, the present invention features a kit for preparing a waterproof adhesive. The kit may comprise deactivated adhesive composition comprising a silane end-capped polymer, a reinforcing extender; and one or more thixotropic agents. The kit also includes a catalyst, referred to herein as an activating catalyst, for activating the deactivated adhesive composition. In preferred embodiments, the activating catalyst is kept separate from the deactivated adhesive composition prior to use of the kit. For example, the deactivated adhesive composition and the catalyst may be stored together but in separate containers or packages. The kit further includes instructions for using the kit to prepare the adhesive. In some embodiments, the instructions include the step of mixing the catalyst with the deactivated adhesive composition to produce the waterproof adhesive. This step is preferably done immediately prior to using the adhesive. When the kit is ready to be used to make the adhesive, the activating catalyst is mixed with the deactivated adhesive composition, thus producing the waterproof adhesive.

In some embodiments, the deactivated adhesive composition is shelf stable for more than six months. In some preferred embodiments, the deactivated adhesive composition is shelf stable for at least nine months. In some other preferred embodiments, the deactivated adhesive composition is shelf stable for at least twelve months or more. Without wishing to limit the invention to a particular theory or mechanism, the kit advantageously provides for an adhesive with a longer shelf life. The shelf life of the adhesive may be stable for 12 months or more depending upon storage conditions.

In some embodiments, the silane end-capped polymer may comprise a silane end-capped polyurethane, a silane end-capped polyether, a silane-end capped polyol, a silane end-capped polyester, or a combination thereof. For example, the silane end-capped polymer may comprise a silane-endcapped urethane and a silane end-capped polyether. In a non-limiting embodiment, the silane end-capped urethane may comprise a flexible binder urethane, a slow-cure urethane, or both.

In some embodiments, the silane end-capped polymer may be produced by reacting a silane component, such as a functional silane, with one or more prepolymers and a catalyst, referred to herein as an in situ catalyst. This in situ catalyst is different from the catalyst that is used to activate the deactivated adhesive composition. The in situ catalyst is effective for catalyzing the end-cap reactions of the silane component and the one or more prepolymers to produce the silane end-capped polymer. In some embodiments, the in situ catalyst may be an aliphatic metal catalyst such as dibutyltindilaurate.

According to some embodiments, the activating catalyst is an amine catalyst. Examples of the catalyst include, but are not limited to, bis(2-dimethylaminoethyl) ether, 1,8-diazabicyclo(5.4.0)undec-7-ene, tris[3-(dimethylamino)propyl]-hexahydro-s-triazine, tris(3-dimethylamino)propylamine, cyclohexyldiethanolamine, diaminobicyclooctane, diisopropylethanolamine, ethanolamine, diethanolamine, dimethylaminopropylamine, dimethylethanolamine, dimethylcethylamine, dimethylhexadecylamine, dimethylcyclohexylamine, dimethyldodecylamine, triethylamine, triethylenediamine, triethanolamine, tetramethylethylenediamine, tetramethylhexamethylenediamine, pentamethyldiethylenetriamine, 1-(2-hydroxypropyl) imidazole, 1,2-dimethylimidazole, 2,2-dimorpholinodiethylether, methylmorpholine, ethylmorpholine, 4-butyl-morpholine, 4-[2-(dimethylamino)ethyl]-morpholine, 4-(2-methoxyethyl)-morpholine, or 4-(2-aminopropyl)morpholine.

In some embodiments, the activating catalyst may be added as a dilution, for example, in methyl ester soy, at a proper concentration to be effective in catalyzing cure. In some embodiments, an amount of the amine catalyst ranges from about 0.05-1.5 wt % of the adhesive. In other embodiments, the amount of the amine catalyst ranges from about 0.1-1 wt % of the adhesive.

In other embodiments, the deactivated adhesive composition comprises about 1-60 wt % of the silane end-capped polymer, about 20-40 wt % of the reinforcing extender, and about 2-6 wt % of the one or more thixotropic agents. In some embodiments, the reinforcing extender may be hydrophobically modified. In some embodiments, the one or more thixotropic agents are hydrophobically modified.

The kit of claim 1, wherein the deactivated adhesive composition further comprises an anti-skinning agent. In some embodiments, the anti-skinning agent may comprise a methylethylketoximino (MEKO) silane according to the formula:

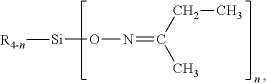

where n ranges from 1 to 4, and R is an alkyl, an alkene, or aryl group. In preferred embodiments, the MEKO silane may be a methyl tris(MEKO)silane, a phenyl tris(MEKO)silane, a vinyl tris(MEKO)silane, a tetrakis(MEKO)silane, a dimethyl bis(MEKO)silane, or a combination thereof. In other embodiments, the second silane component may be at a range of about 2-10 wt % of the mixture.

According to some other embodiments, the kit may further comprise a quenching agent, a tackifier, one or more moisture scavengers, a magnetic agent, a pigment, or a combination thereof. These agents may be added as part of the deactivated adhesive composition. Alternatively, these agents may be added along with the activating catalyst to the deactivated adhesive composition.

In some embodiments, the waterproof adhesive coating kit is used to coat a substrate According to some embodiments, the present invention features a method of coating a substrate comprising providing the waterproof adhesive coating kit; prior to coating the substrate, adding the catalyst to the deactivated adhesive composition to form an activated adhesive; and coating the substrate with the activated adhesive. In preferred embodiments, a cured coating of the activated adhesive is waterproof, hydrolytically stable, and pH-resistant.

According to other embodiments, the present invention features a polymeric matrix adhesive composition. The adhesive may comprise one or more prepolymers, a functional silane, a first catalyst (in-situ catalyst), a reinforcing extender, one or more thixotropic agents; and a second catalyst (activating catalyst). Preferably, the second catalyst is different from the first catalyst. In some embodiments, the second catalyst is an amine catalyst as previously described. When the adhesive is cured, the cured product is waterproof, hydrolytically stable, and pH-resistant. In further embodiments, the composition may also include an anti-skinning agent, a quenching agent, a tackifier, one or more moisture scavengers, a magnetic agent, a pigment, or a combination thereof.

It is another objective of the present invention to prepare adhesives. In some embodiments, the present invention features a method of producing a waterproof adhesive. The method may comprise preparing a deactivated adhesive composition, and then adding a second catalyst (activating catalyst) to the deactivated adhesive composition. In some embodiments, the step of preparing the deactivated adhesive composition may comprise reacting one or more prepolymers, a functional silane, and a first catalyst (in situ catalyst) to produce a silane end-capped polymer, and adding a reinforcing extender and one or more thixotropic agents to the silane end-capped polymer. In other embodiments, the method may further comprise adding an anti-skinning agent, a quenching agent, a tackifier, one or more moisture scavengers, a magnetic agent, a pigment, or a combination thereof when preparing the deactivated adhesive composition.

In some embodiments, the second catalyst is different from the first catalyst. The second catalyst may be an amine catalyst, such as those previously listed herein. In preferred embodiments, the second catalyst is kept separate from the deactivated adhesive composition and only added to the deactivated adhesive composition immediately prior to using the waterproof adhesive. For example, when the adhesive is needed or desired to be used, the second catalyst is added to the deactivated adhesive composition at the time. In other words, there is a period of time between preparing the deactivated adhesive composition and adding the second catalyst to the deactivated adhesive composition. This period of time may be more than six months, preferably at least twelve months or longer. In preferred embodiments, the shelf life of the adhesive is stable for 12 months or more depending upon storage conditions

According to other embodiments, the present invention features a polymeric matrix adhesive composition comprising a silane end-capped polymer component comprising a silane and a urethane component, a first catalyst, a second catalyst, a reinforcing extender, one or more thixotropic agents, and an anti-skinning agent. The urethane component may comprise a flexible binder urethane prepolymer, a slow-cure urethane, or both. In preferred embodiments, the second catalyst is added to the composition immediately before coating a surface. In other embodiments, the composition is waterproof, hydrolytically stable, and pH-resistant. In another embodiment, the composition further comprises a quenching agent, a tackifier, one or more moisture scavengers, a magnetic agent, and a pigment.

According to another embodiment, the present invention features magnetic waterproof coatings. In preferred embodiments, a magnetic agent may impart magnetic characteristics to the coating. As a non-limiting example, the magnetic characteristics of the cured coating may allow for the attachment of magnetic materials to the surface of the cured coating without adhering the material to the surface of the cured coating using adhesive bonds but rather holding the magnetic material in place using magnetic force. In some embodiments, the magnetic material may comprise a flooring or wall coating material such as: a ceramic or vinyl tile; a wooden, composite, or synthetic plank; a carpeting; or another material suitable for flooring or wall covering. The magnetic material may be impregnated with a magnetic agent or affixed to a magnet.

In selected embodiments, the magnetic agent may comprise any magnetic agent, including but not limited to, ferrite, iron filings, and iron oxide, magnetite, or ferrous oxide. In some embodiments, the magnetic material may be removed from the surface of the cured coating without affecting or damaging the coating. In further embodiments, this removability may allow for multiple subsequent applications of different magnetic materials. As a non-limiting example, a damaged portion of the magnetic material may be easily replaced with a new portion. As another non-limiting example, a magnetic flooring material with one design may be easily replaced with a flooring material with another design without replacing the magnetic coating.

In one embodiment, the present invention features a method of magnetically attaching a flooring material to a substrate. As a non-limiting example, the method may comprise: coating the substrate with any of the magnetic coating compositions of the present invention; providing a magnetic flooring material; and applying the magnetic flooring material to the coated substrate. In preferred embodiments, the magnetic flooring material may be held in place on the coated substrate by a magnetic force between the magnetic flooring material and the coating. In further embodiments, the magnetic flooring material may be removed from the magnetic coating without affecting the magnetic coating.

Polyurethane prepolymers may be formed by combining an excess of diisocyanate with polyol. As depicted in the reaction scheme below, one of the NCO groups of the diisocyanate reacts with one of the OH groups of the polyol, the other end of the polyol reacts with another diisocyanate, and thus the resulting prepolymer has an isocyanate group on both ends. The prepolymer is a diisocyanate itself, and it reacts like a diisocyanate but with several important differences. When compared with the original diisocyanate, the prepolymer has a greater molecular weight, a higher viscosity, a lower isocyanate content by weight (% NCO), and a lower vapor pressure. Instead of a diol, a triol or higher functional polyol could also be used for the polyol in the reaction. Molar ratios of diisocyanate to polyol greater than 2:1 can also be used. These are called quasi-prepolymers.

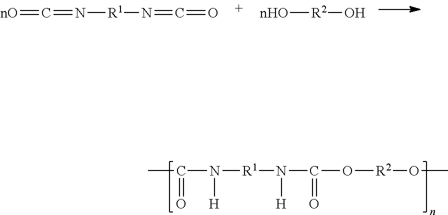

As used herein, a slow-cure urethane prepolymer is a polyisocyanate prepolymer based on diphenylmethane diisocyanate (MDI). High functionality (Fn) and NCO content gives increased reactivity to this component. On its own this prepolymer will form highly rigid films and must be modified for proper application requirements. As used herein, a flexible binder urethane prepolymer is a polyisocyanate prepolymer based on diphenylmethane diisocyanate (MDI). Lower functionality and NCO content makes this prepolymer less reactive and slower curing. Higher equivalent weight gives this component additional flexibility and gap bridging properties. Tables 1-3 provide standards for the slow-cure urethane prepolymer and the flexible binder urethane prepolymer. A single slow-cure urethane prepolymer possessing properties similar to the mixture of the two components could be used. Equivalents or substitutes are within the scope of the present invention.

TABLE 1

| | | Sp | | | Viscosity |
|---|---|---|---|---|---|
| Urethane | | Gravity @ | % | | cps @ |
| Prepolymer | Fn | 25° C. | NCO | Eq Wt | 25° C. |
| Slow-cure urethane | 2.54 | 1.12 | 15.8 | 266 | 3400 |
| prepolymer | | | | | |
| Flexible binder | 2.00 | 1.10 | 9.7 | 433 | 2000 |
| urethane | | | | | |
| prepolymer | | | | | |

TABLE 2
SLOW-CURE URETHANE PREPOLYMER SPECIFICATIONS

| Property | Value |
|---|---|
| NCO content, % | 15.0-23.0 |
| Viscosity @ 25 C., cps | 3000-8000 |
| Appearance | Brown liquid |
| Eq wt | 250-270 |
| Fn | 2.5-2.55 |

TABLE 3
FLEXIBLE BINDER URETHANE SPECIFICATIONS

| Property | Value |
|---|---|
| NCO content, % | 2.0-10.0 |
| Viscosity @ 25 C., cps | 1500-3500 |
| Appearance | Clear liquid |
| Eq wt | 425-550 |
| Fn | 2.00 |

In one embodiment, a silane is used to react with the urethane prepolymers to form a silane end-capped polymer, i.e. a silane end-capped polyurethane. Non-limiting examples of silanes include alkoxysilanes such as amino-functional alkoxysilanes, gamma-aminopropyltrimethoxysilane, benzylamino, chloropropyl, epoxy, epoxy/melamine, ureido, vinyl-benzyl-amino, the like, or a combination thereof. The alkoxysilane is not limited to the aforementioned examples.

In another embodiment, the urethane prepolymer may be substituted with a polycarboxylate (e.g., to create a silane end-capped polycarboxylate). In another embodiment, the flexible binder urethane prepolymer or the slow-cure urethane prepolymer may be substituted or mixed in with a tackifier. Examples of tackifiers include, but are not limited to, polyether polyol, carboxylic diols, and alkoxy-functionalized silicone polymers such as polydimethyl siloxane. For illustrative purposes, the tackifier may be a high molecular weight (e.g., greater than about 4,000 g/mol) polyether polyol. The polyether polyol may help increase coating flexibility. For example, the polyether polyol increases elongation and flexible adhesion yet maintains formulation stability. The polyether polyol may help provide a dry film suitable for use with flooring substrates that demonstrate dimensional properties of expansion and contraction. A softer or more flexible product may also function as a sound abatement system (e.g., for wood flooring installations). A softer or more flexible product may also produce an adhesive bond line that holds carpet tile firmly yet allows removal via peeling the floor back (e.g., at a severe angle) creating cohesive failure of the adhesive. Table 4 describes a non-limiting example of properties of a polyether polyol.

TABLE 4
TYPICAL PROPERTIES OF POLYETHER POLYOL

| Property | Value |
|---|---|
| Appearance | Clear viscous liquid |
| Specific Gravity at 20° C. | 1.01 |
| Viscosity at 25° C., cps | 980 |
| Flash Point, PMCC, ° C. | 213 |
| Bulk Density, lb/gal | 8.38 |

In some embodiments, silane-modified polyether or polyester materials may be incorporated into the adhesive composition of the present invention as coupling agents to reduce polyisocyanate content. In other embodiments, the silane-modified polyether or polyester materials may replace the urethane component. They can be used in combination with silane terminated urethane polymers or as functional substitutes.

Without wishing to be bound to a particular theory or mechanism, the silane-modified polyether or polyester materials can modify the mechanical properties of the adhesive, produce clear formulations, and promote adhesion. These materials may be silane terminated. The material may have a density averaging about 1.11 to 1.15 g/ml, and a viscosity in the range of about 1800 to 2000 mPa-s.

In non-limiting embodiments, the silane-modified polyether or polyester may be GENIOSIL® Silane-Modified polymer products (https://www.wacker.com/cms/en-us/products/product-groups/silane-modified-polymers/silane-modified-polymers.html).

Hydrophobic modification is the treatment of a substrate's surface so that it becomes non-polar. A surface can be polar because of the hydrogen bonding locations. By eliminating or reducing the hydrogen bonding at the surface, the surface is shielded from interacting with water molecules and is therefore rendered hydrophobic. For calcium carbonate, it is theorized that although calcium carbonates do not form stable bonds with silicates, the low molecular weight and low surface energy of the silicates allow for the silicates to penetrate porous structures and encapsulate the substrate in a silica-rich network.

In some embodiments, the hydrophobically modified reinforcing extender may contribute to the overall waterproof quality of the cured, waterproof polymeric matrix coating. In other embodiments, the hydrophobically modified reinforcing extender provides an increase in mechanical strength, provides dimensional stability, builds viscosity, reduces shrinkage, and reduces cracking in the coating. For example, a reinforcing extender, such as a mineral component can be hydrophobically modified by adding a silane or aliphatic silane. Examples of mineral components include, but are not limited to, calcium carbonate, limestone, layered clays, aluminates, hydrotalcite and the like. Illustrative of a hydrophobically modified reinforcing extender is a hydrophobically modified calcium carbonate.

A thixotropic agent can function as a thickener and/or to build viscosity. Preferably, the thixotropic agent is hydrophobically modified. In some embodiments, the following may be used as thixotropic agents: fumed silica, hydrogenated castor oil derivatives, hydrophobically modified cellulosic materials, surface modifiers based on polyethylene, polypropylene and PTFE technologies, hydrated magnesium aluminosilicate and the like.

In some embodiments, an aliphatic quenching agent can terminate chemical reactions such that the coating formulation has minimal to no reactivity (i.e. inert). A non-limiting example of the aliphatic quenching agent is an aliphatic fatty acid ester mixture. The aliphatic fatty acid ester mixture is a UV stable, zero VOC solvent having low viscosity, possessing high flash point and low volatility. This solvent readily biodegrades in the environment (>90% in 28 days). This solvent is not derived from petroleum distillates, is non-toxic, non-hazardous under RCRA, non-HAPS and meets clean air solvent certification. Aliphatic Fatty Acid Ester Mixture is sold under various trade names, for example: Solvation (Shepard Bros, La Habra, Calif.) and Promethean ME (Promethean Biofuels, Temecula, Calif.). In some embodiments, the following agents may be used as aliphatic fatty acid esters: fatty acid methyl esters (FAME) such as myristic acid, palmitic acid, palmitoleic acid, stearic acid, oleic acid, linoleic acid, eicosanoic acid, docosenoic acid and the like, which are molecules in biodiesel derived from the transesterification of vegetable oils and the like.

Further non-exhaustive examples of quenching agents include mixtures of aliphatic hydrocarbons of various molecular weights and fractionation containing alkanes, alkenes and alkynes derived, but not exclusively, from petroleum sources. Mixtures may also contain natural hydrocarbons from biological sources such as terpenes and isoprene and the like. These mixtures exhibit partial solubility of the urethane formulation components. The following tables are non-limiting examples of properties of quenching agents. Equivalents or substitutes are within the scope of the present invention.

TABLE 5.1
Petroleum Distillates

| | |
|---|---|
| Molecular Weight: | approximately 87-114 |
| Odor: | pleasant aromatic odor |
| Boiling Range: | 95-160° C. |
| Specific Gravity: | 0.7275-0.7603 |
| Color: | clear, water white to yellow |
| Vapor Pressure: | 2-20 mm Hg at 20° C. |
| Flashpoint: | −6.7 to 12.8° C. (closed cup) |
| Synonyms: | benzene, naphtha 76, ligroin, |
| | high boiling petroleum ether |
| Molecular Species: | C₇-C₁₁ |

TABLE 5.2
Terpenes and Isoprene

| | |
|---|---|
| Molecular Weight: | C₅H₈ |
| Molar Mass: | 68.12 g/mol |
| Density: | 0.681 g/cm³ |
| Melting Point: | −143.95° C. |
| Boiling Point: | 34.067° C. |

TABLE 5.3
Stoddard Solvent

| | |
|---|---|
| Molecular Weight: | approximately 135-145 |
| Odor: | kerosene-like |
| Boiling Range: | 160-210° C. |
| Specific Gravity: | 0.75-0.80 |
| Color: | colorless |
| Vapor Pressure: | 4-4.5 mm Hg at 25° C. |
| Flashpoint: | 37.8° C. (closed cup) |
| Synonyms: | 140 flash solvent, odorless |
| | solvent and low end point solvent |
| Molecular Species: | C₉-C₁₁ |

TABLE 5.4
Mineral spirits

| | |
|---|---|
| Molecular Weight: | approximately 144-169 |
| Odor: | pleasant sweet odor |
| Boiling Range: | 150-200° C. |
| Specific Gravity: | 0.77-0.81 |
| Color: | clear, water white |
| Vapor Pressure: | 0.8 mm (Hg) at 20° C. |
| Flashpoint: | 30.2-40.5° C. (closed cup) |
| Synonyms: | white spirits, petroleum |
| | spirits, and light petrol |
| Molecular Species: | C₉-C₁₂ |

In other embodiments, a catalyst is used to accelerate chemical reactions and promote curing of the coating. The catalyst is preferably an aliphatic metal catalyst such as dibutyltindilaurate. The percent weight of the aliphatic metal catalyst is about 0.001 to 5% (e.g., 0.1%). Other examples of the aliphatic metal catalyst include, but are not limited to, organometallic compounds based on mercury, lead, tin, bismuth, zinc, the like, or a combination thereof.

In further embodiments, a moisture scavenger may be used to limit the amount of moisture contamination absorbed from the atmosphere. In one embodiment, the moisture scavenger comprises vinyl-functionalized methoxy silane, such as vinyltrimethoxysilane.

In yet other embodiments, adhesion promoters may be used as cross-linking agents to improve adhesion between inorganic fillers, basic materials and resins. Examples of adhesion promoters include, but are not limited to, silane based crosslinkers such as oximesilane crosslinkers, alkyl-functionalized silane crosslinkers, aminosilane crosslinkers, and alkoxysilane crosslinkers such as glycidoxypropyltrimethoxysilane. For example, glycidoxypropyltrimethoxysilane is an epoxy substituted alkoxysilane used as a cross-linking agent and adhesion promoter.

As another example, the crosslinkers may be oxime-silane based crosslinkers such as methylethylketoximino (MEKO) silanes. Non-limiting examples of MEKO silanes include methyl tris(MEKO)silane, phenyl tris(MEKO)silane, vinyl tris(MEKO)silane, tetrakis(MEKO)silane, and dimethyl bis(MEKO)silane. Table 6 shows exemplary properties of MEKO silanes. Equivalents or substitutes are within the scope of the present invention.

Oxime silane-based crosslinkers allow for neutral moisture-cure. Using these silane compounds, 2-butanone oxime or MEKO is released, but no acetic acid or amine is released unlike in acid or alkaline crosslinking systems. Without wishing to limit the invention to a particular theory or mechanism, it is believed that MEKO functions by binding drying agents and metal salts that catalyze the oxidative crosslinking of the coating mixture. Once the coating mixture has an hour or so to dwell on the concrete surface, MEKO evaporates, thereby further allowing the crosslink reaction to proceed.

TABLE 6
MEKO SILANE CROSSLINKERS

| Property | Value |
|---|---|
| Density at 20° C. | 0.94-0.995 g/cm³ |
| Refractive Index at 20° C. | 1.45-1.483 |
| Appearance | Transparent clear liquid |
| Color | Colorless to yellowish |

In still other embodiments, additional tackifiers may be used to plasticize the coating and/or reduce moisture sensitivity and/or enhance flexibility and adhesion to low energy flooring substrate. In some embodiments, the tackifier is the methyl ester of rosin. Below is a non-limiting example of a tackifier (Table 7). Equivalents or substitutes are within the scope of the present invention.

Methyl Ester of Rosin has a resinous nature, clarity, high refractive index, low vapor pressure, high boiling point, and good thermal stability. It has excellent surface wetting properties and is compatible and miscible with a wide variety of materials. It is soluble in esters, ketones, alcohols, ethers, coal tar, petroleum hydrocarbons, and vegetable and mineral oils. It is insoluble in water. It is compatible at all ratios, or in limited but practically useful proportions, with nitrocellulose, ethylcellulose, chlorinated rubber, and most other film-formers; with water-soluble film-formers such as starch, casein, and glue; with natural and synthetic rubbers, natural and synthetic resins, waxes, and asphalt. It is incompatible with cellulose acetate and polyvinyl acetate. These physical properties, plus its wide compatibility, make it useful in a variety of applications, including lacquers, inks, paper coatings, varnishes, coatings, sealing compounds, plastics, wood preservatives and perfumes. To assure minimum odor of products in which it is used, it is given a special steam sparging treatment. Methyl ester of rosin is used in lacquers to contribute high gloss, clarity, and fullness; as a plasticizing resin in pressure-sensitive and hot-melt adhesives for superior adhesion, resistance to sweating or exudation, and reduced moisture sensitivity; as a fixative and carrier in perfumes and cosmetic preparations for its low vapor pressure, neutral character, pleasant odor, and high co-solvent action; for various combinations of these and other properties in inks, varnishes, and asphalts; as a replacement for castor oil; as a rubber softener; and in many similar applications. Methyl ester of rosin is sold under various trade names, for example: Abalyn (Eastman Chemical BV, The Netherlands)

TABLE 7
METHYL ESTER OF ROSIN

| Property | Value |
|---|---|
| Density at 25° C. | 1.04 kg/dm³ |
| Water Solubility | Insoluble |
| Viscosity at 25° C. | 3000-6000 mPa · s |
| Flash Point | 170° C. |
| Refractive Index at 20° C. | 1.530 |

In one embodiment, a magnetic waterproof coating composition may comprise a blend of prepolymer (e.g., urethane prepolymer) that is modified with a silane, e.g., a trimethoxy substituted amino functional silane, in the manufacturing process (e.g. in situ). In some embodiments, a mixture of naturally derived aliphatic fatty acid ester is used as a diluent/compatibilizer that assists in the incorporation of hydrophobically-treated calcium carbonates and hydrophobically-treated fumed silica viscosifiers. Final coating formulation viscosity may be adjusted to provide trowelability and overall aesthetic.

The coating can undergo a silanol-bridge mechanism to form waterproof chemical bonds, i.e. urethane and silanol condensation bonds, to the concrete surface primed with the degassing primer. In some embodiments, the adhesive bond that is formed is alkali stable to pH 14. Evaluation of concrete moisture according to ASTM F1869 may exceed 15 lbs/1000 sf/24 hrs and according to ASTM F2170 to 100% RH. Generally, the silanol condensation reaction is waterproof, solvent proof, and heat resistant. The cured coating creates a hydrophobic barrier to liquid water, yet allows water vapor to move through the concrete/primer/coating/flooring matrix.

According to other embodiments, the present invention features a magnetic, waterproof coating composition comprising a cured mixture comprising a urethane component, a first silane component, an anti-skinning agent component comprising a methylethylketoximino (MEKO) silane, a reinforcing extender, a magnetic agent, and a thixotropic agent. Preferably, the coating composition is waterproof, hydrolytically stable, and pH-resistant. In some embodiments, the magnetic, waterproof coating composition may comprise a magnetic coating to which materials may be affixed by magnetic force.

In one embodiment, the MEKO silane may be according to the formula:

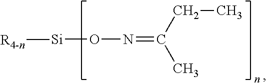

where n ranges from 1 to 4, and R is an alkyl, an alkene, or aryl group. In some embodiments, the MEKO silane may comprise a methyl tris(MEKO)silane, a phenyl tris(MEKO)silane, a vinyl tris(MEKO)silane, a tetrakis(MEKO)silane, a dimethyl bis(MEKO)silane, or a combination thereof. In other embodiments, the second silane component is at a range of about 2-10 wt % of the composition.

In one embodiment, the urethane component can range from about 30-50 wt % of the mixture. In another embodiment, the urethane component can have an average NCO content of about 7 to 23%. In some embodiments, the urethane component may comprise at least one urethane selected from a group consisting of a slow-cure urethane having a functionality (Fn) of about 2.5 to 2.55 and an NCO content of about 15 to 23%, and a flexible binder urethane having a functionality (Fn) of about 2 and an NCO content of about 2 to 10%.

In some embodiments, the first silane component may be an amino-functional alkoxysilane polymer having terminal silanol groups. In other embodiments, the first silane component is at a range of about 2-10 wt % of the mixture. In still other embodiments, the reinforcing extender is at a range of about 2-10 wt % of the mixture. In further other embodiments, the thixotropic agent is at a range of about 2-10 wt % of the mixture.

In one embodiment, the cured mixture may further comprise a magnetic agent. Non-limiting examples of magnetic agents include ferrite, iron, iron filings, and ferrous oxide. In some embodiments, the magnetic agent is at a range of about 0.1-1 wt % of the mixture. In other embodiments, the magnetic agent is at a range of about 1-2, 2-3, 3-4, 4-5, 5-6, 6-7, 7-8, 8-9, 9-10, 10-12, 10-15, 12-14, 14-16, 16-18, 18-20, or greater than 20 wt % of the mixture.

In one embodiment, the cured mixture may further comprise about 15-40 wt % of a polyol component having an average molecular weight of at least about 4,000 g/mol. In another embodiment, the cured mixture may further comprise about 5-15 wt % of an aliphatic quencher. In a further embodiment, the cured mixture may further comprise about 2-10 wt % of a tackifier.

In one embodiment, the cured mixture may further comprise carbon nanofibers. The carbon nanofibers may be effective for increasing electrical conductivity of the coating composition. In some embodiments, each carbon nanofiber can have a fiber diameter of about 120 to 160 nm, and a dispersive surface energy of about 120 to 140 mJ/m². Without wishing to limit the invention to a particular theory or mechanism, the carbon nanofibers can provide enhanced electrical conductivity over a broad range along with mechanical reinforcement of the coating. Other benefits provided by the carbon nanofibers include improved heat distortion temperatures and increased electromagnetic shielding.

In another embodiment, the cured mixture may further comprise an inherently static dissipative (IDP) component effective for decreasing surface resistance of the coating composition. Other benefits of the IDP component include the ability to ground potentially hazardous charges. The IDP component can have a surface resistivity of about 1⁰⁷ to 1¹⁰ Ω/sq. Non-limiting examples of the IDP component include polypropylene, polystyrene, polyethylene, and acrylic polymers.

According to one embodiment, the present invention features a curable pressure sensitive, magnetic, waterproof coating mixture comprising a urethane component, a first silane component, a second silane component comprising a methylethylketoximino (MEKO) silane, a reinforcing extender, a magnetic agent, and a thixotropic agent. Preferably, when the coating mixture is applied to a substrate, the coating mixture has a tack-free time of at least about 90 minutes. More preferably, the coating mixture is waterproof, hydrolytically stable, and pH-resistant. Without wishing to limit the invention to a particular theory or mechanism, the coating may be activated to cure to a hardened state when applied to a substrate and pressure is applied to the coating.

In some embodiments, the MEKO silane may be according to the formula:

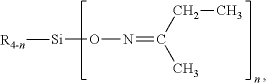

where n ranges from 1 to 4, and R is an alkyl, an alkene, or aryl group. The MEKO silane may comprise a methyl tris(MEKO)silane, a phenyl tris(MEKO)silane, a vinyl tris(MEKO)silane, a tetrakis(MEKO)silane, a dimethyl bis(MEKO)silane, or a combination thereof. In other embodiments, the second silane component is at a range of about 2-10 wt % of the coating mixture.

In other embodiments, the urethane component can range from about 30-50 wt % of the coating mixture. In another embodiment, the urethane component can have an average NCO content of about 7 to 23%. In one embodiment, the urethane component may comprise at least one urethane selected from a group consisting of a slow-cure urethane having a functionality (Fn) of about 2.5 to 2.55 and an NCO content of about 15 to 23%, and a flexible binder urethane having a functionality (Fn) of about 2 and an NCO content of about 2 to 10%.

In one embodiment, the first silane component may be an amino-functional alkoxysilane polymer having terminal silanol groups. In another embodiment, the first silane component is at a range of about 2-10 wt % of the coating mixture. In yet another embodiment, the reinforcing extender is at a range of about 2-10 wt % of the coating mixture. In a further embodiment, the thixotropic agent is at a range of about 2-10 wt % of the coating mixture.

In some embodiments, the coating mixture may further comprise about 15-40 wt % of a polyol component having an average molecular weight of at least about 4,000 g/mol. In other embodiments, the coating mixture may further comprise about 5-15 wt % of an aliphatic quencher. In still other embodiments, the coating mixture may further comprise about 2-10 wt % of a tackifier.

In some embodiments, the coating mixture may further comprise carbon nanofibers effective for increasing electrical conductivity of the coating composition. Each carbon nanofiber can have a fiber diameter of about 120 to 160 nm, and a dispersive surface energy of about 120 to 140 mJ/m².

In other embodiments, the coating mixture may further comprise an inherently static dissipative (IDP) component effective for decreasing surface resistance of the coating composition. Examples of the IDP component include, but are not limited to, polypropylene, polystyrene, polyethylene, and acrylic polymers. Coating mixtures having the carbon fibers and IDP component would be suitable for use in electronics manufacturing clean rooms.

Table 8 describes a non-limiting example of a pressure sensitive coating composition.

| Component | Percent weight |
|---|---|
| Urethane prepolymer | 30-50 |
| Polyol (4000 MW) | 20-40 |
| Amino-functional alkoxysilane | 2-5 |
| Quenching agent | 5-15 |
| Tackifier | 3-10 |
| Oxime silane | 3-10 |
| Reinforcing extender | 3-10 |
| Thixotropic agent | 3-10 |
| Catalyst (e.g. aliphatic metal) | 0.01-1 |
| Pigment | 0.01-1 |
| Magnetic agent | 1-10 |

Table 9 describes another non-limiting example of a pressure sensitive coating composition.

| Component | Percent weight |
|---|---|
| Urethane prepolymer | 30-50 |
| Polypropylene glycol | 20-40 |
| Amino-functional alkoxysilane | 2-5 |
| aliphatic methyl-ester | 5-15 |
| methyl ester rosin | 3-10 |
| MEKO silane | 3-10 |
| Reinforcing extender | 3-10 |
| Thixotropic agent | 3-10 |
| Vinyltrimethoxysilane | 0.005-0.015 |
| Dibutyltindilaurate | 0.01-1 |
| Pigment | 0.01-1 |
| Magnetic agent | 1-10 |

Table 10 describes an exemplary coating composition, referred to as the LVT coating.

| Component | Percent weight |
|---|---|
| Slow-cure urethane prepolymer | 55-65 |
| Flexible binder urethane prepolymer | 15-30 |
| Amine-functionalized methoxysilane | 0.01-1.5 |
| Dibutyltindilaurate | 0.001-.01 |
| Aliphatic fatty acid ester mixture | 5-10 |
| Vinyltrimethoxysilane | 0.005-0.015 |
| Reinforcing extender | 3-10 |
| Thixotropic agent | 1-5 |
| Methyl ester of rosin | 0.5-1.5 |
| Pigment | 0.005-0.015 |
| Magnetic agent | 1-10 |

Alternatively, the flexible binder urethane may be substituted by a polyether or an alkoxy-functionalized silicon polymer. For instance, according to one embodiment, the polymeric matrix coating composition may comprise a cured product of a silane end-capped polymeric component comprising a silane and a urethane component, a polyether diol having an average molecular weight of at least about 4,000 g/mol, a reinforcing extender, and a thixotropic agent. The urethane component may comprise a slow-cure urethane having a functionality (Fn) of about 2.5 to 2.55 and an NCO content of about 15 to 23%. Preferably, a weight ratio of the slow-cure urethane to the polyether diol is about 1:2 to 2:1. In some embodiments, the reinforcing extender and thixotropic agent are hydrophobically modified. In other embodiments, the composition may further comprise about 6-10 wt % of an aliphatic quencher.

In one embodiment, the composition may comprise about 40-55 wt % of a silane end-capped polymer component, about 25-40 wt % of the polyether diol, about 3-7 wt % of the reinforcing extender, and about 2-5 wt % of the thixotropic agent. The weight ratio of the slow-cure urethane to the polyether diol is about 3:2. In another embodiment, the composition may comprise about 15-30 wt % of a silane end-capped polymer component, about 40-55 wt % of the polyether diol, about 3-7 wt % of the reinforcing extender, and about 2-5 wt % of the thixotropic agent. The weight ratio of the slow-cure urethane to the polyether diol is about 3:5.

Table 11 describes an exemplary coating composition, referred to as a VCT coating.

| Component | Percent weight |
|---|---|
| Slow-cure urethane prepolymer | 40-55 |
| Polyether | 25-40 |
| Amine-functionalized methoxysilane | 0.01-1.5 |
| Dibutyltindilaurate | 0.001-.01 |
| Aliphatic fatty acid ester mixture | 5-10 |
| Vinyltrimethoxysilane | 0.005-0.015 |
| Reinforcing extender | 3-10 |
| Thixotropic agent | 1-5 |
| Methyl ester of rosin | 0.5-1.5 |
| Pigment | 0.005-0.015 |
| Magnetic agent | 1-20 |

Table 12 describes an exemplary coating composition, referred to as a VSF coating.

| Component | Percent weight |
|---|---|
| Slow-cure urethane prepolymer | 10-30 |
| Polyether | 40-55 |
| Amine-functionalized methoxysilane | 0.01-1.5 |
| Dibutyltindilaurate | 0.001-.01 |
| Aliphatic fatty acid ester mixture | 5-10 |
| Vinyltrimethoxysilane | 0.005-0.015 |
| Reinforcing extender | 3-10 |
| Thixotropic agent | 1-5 |
| Methyl ester of rosin | 0.5-1.5 |
| Pigment | 0.005-0.015 |
| Magnetic agent | 1-40 |

In some embodiments, the silane end-capped polymeric component comprises a urethane component and a silane component. The silane end-capped polymeric component can form a silanol bridge with the flooring substrate. The silane can be an aminofunctional silane to promote adhesion between inorganic and organic polymers and the like. The silane end-capped polymeric component can range in molecular weight from about 3,000 g/mol to 10,000 g/mol.

In other embodiments, the urethane component facilitates a moisture cure process. In a moisture cure process, water is removed from the coating by reacting with the free isocyanate from the excess urethane prepolymer. The water and isocyanate react to form carbamic acid, which is highly unstable and therefore breaks down into an amine and carbon dioxide. The gaseous carbon dioxide is released from the coating matrix. The amine reacts with other isocyanate molecules and forms a urea linkage, which contributes to an increased crosslink density of the coating.

In some embodiments, the urethane component comprises pure urethane. In other embodiments, the urethane component comprises hybrid polymers of epoxy and urethane. In still other embodiments, the urethane component may be replaced with a polyol of varying molecular weight, ranging from 4,000 g/mol to 10,000 g/mol and having a Hydroxyl number of less than 29.5 mg KOH/g Polyol. As understood by one of ordinary skill, the hydroxyl number is the weight of KOH in milligrams that will neutralize the acid from 1 gram of polyol. In further embodiments, the urethane component may be combined with the polyol of varying molecular weight, but preferably, at least 4,000 g/mol. In some embodiments, the polyol is a polyether polyol or polypropylene glycol. Preferably, a weight ratio of the urethane component to the polyol is about 1:2 to 2:1.

Table 13 describes another non-limiting example of the coating composition. Pigment is not required in order to obtain performance results. To achieve a waterproof, pH-resistant formulation, the incorporation of hydrophobically modified additives carried by an aliphatic hydrocarbon quenching agent may be necessary. The quencher may separate the urethanes (e.g., increase the activation energy so that the formulation is not reactive or has little reactivity). The silane component (e.g., gamma-aminopropyltrimethoxysilane) end-caps the urethane prepolymers. Dibutyltindilaurate is an aliphatic metal catalyst used in some embodiments to initiate cure of the coating by moisture. In some embodiments, the catalyst is used to accelerate the reaction (e.g., the reaction in the presence of the catalyst may be allowed to react for about 10 to 20 minutes, about 15 to 20 minutes, about 20 to 30 minutes, or more than about 30 minutes, etc.). In other embodiments, substitution of the catalyst by other chemistries is possible. In still other embodiments, the catalyst may not be required.

TABLE 13

| Component | Percent weight |
|---|---|
| Slow-cure urethane prepolymer | 50 |
| Flexible binder urethane prepolymer | 35 |
| Gamma-aminopropyltrimethoxysilane | 1.5 |
| Dibutyltindilaurate | 0.1 |
| Aliphatic fatty acid ester mixture | 10 |
| Vinyltrimethoxysilane | 0.7 |
| Reinforcing extender | 15 |
| Thixotropic agent | 15 |
| 3-glycidoxypropyltrimethoxysilane | 0.35 |
| Pigment | 0.2 |

Table 14.1, Table 14.2, and Table 14.3 describe other non-limiting examples of the coating composition. As previously stated, pigment is not required in order to obtain performance results.

TABLE 14.1

| Component | Percent weight |
|---|---|
| Slow-cure urethane prepolymer | 50 |
| Flexible binder urethane prepolymer | 35 |
| Silane (e.g., amino-functional alkoxysilane) | 1.5 |
| Catalyst (e.g., aliphatic metal catalyst) | 0.1 |
| Quenching agent (e.g., aliphatic hydrocarbon | 10 |
| quenching agent) | |
| Moisture scavenging agent | 0.7 |
| Reinforcing extender | 15 |
| Thixotropic agent | 15 |
| Pigment | 0.2 |

TABLE 14.2

| | Ranges of |
|---|---|
| Component | Percent Weights |
| Silane end-capped polymeric material | 65-95 |
| MEKO silane | 3-10 |
| Aliphatic quencher | 5-15 |
| Reinforcing extender | 5-15 |
| Thixotropic agent | 3-15 |

TABLE 14.3

| | Ranges of |
|---|---|
| Component | Percent Weights |
| Urethane prepolymer | 65-95 |
| Silane (e.g., amino-functional alkoxysilane) | 0.5-5 |
| MEKO silane | 3-10 |
| Aliphatic quencher | 5-15 |
| Reinforcing extender | 5-15 |
| Thixotropic agent | 3-15 |

Table 15 describes another non-limiting example of the coating composition. A single urethane prepolymer possessing properties similar to the mixture of the slow-cure urethane prepolymer and the flexible binder urethane prepolymer used in the previous examples is substituted. Pigment is not required in order to obtain performance results.

TABLE 15

| Component | Percent Weight |
|---|---|
| Urethane prepolymer | 85 |
| Silane (e.g., amino-functional alkoxysilane) | 1.5 |
| MEKO silane | 3-10 |
| Catalyst (e.g., aliphatic metal catalyst) | 0.1 |
| Quenching agent (e.g., aliphatic hydrocarbon | 10 |
| quenching agent) | |
| Moisture scavenging agent | 0.7 |
| Reinforcing extender | 15 |
| Thixotropic agent | 15 |
| Pigment | 0.2 |

Table 16 describes another non-limiting example of the coating composition. Pigment is not required in order to obtain performance results.

TABLE 16

| Component | Percent weight |
|---|---|
| Slow-cure urethane prepolymer | 45-55 |
| Flexible binder urethane prepolymer | 30-40 |
| Amino-functional alkoxysilane | 1-5 |
| MEKO silane | 3-10 |
| Aliphatic metal catalyst | 0.05-5 |
| Aliphatic hydrocarbon quenching agent | 5-15 |
| Moisture scavenging agent | 0.1-1 |
| Reinforcing extender | 10-20 |
| Thixotropic agent | 10-20 |
| Pigment | 0-1 |

Table 17.1 and 17.2 are non-limiting examples of the sleeping Aquaflex® coating composition. Pigment is not required in order to obtain performance results.

TABLE 17.1

| Component | Percent weight |
|---|---|
| Silane end-capped polymeric material | 65-95 |
| MEKO silane | 3-10 |
| Aliphatic quencher | 5-15 |
| Reinforcing extender | 5-15 |
| Thixotropic agent | 3-15 |
| Amine catalyst (added to mixture prior to | 0.05-2 |
| applying coating) | |

TABLE 17.2

| Component | Percent Weight |
|---|---|
| Urethane prepolymer | 60-95 |
| Silane (e.g., amino-functional alkoxysilane) | 0.5-5 |
| MEKO silane | 3-10 |
| First catalyst (e.g., aliphatic metal catalyst) | 0.01-0.1 |
| Quenching agent (e.g., aliphatic | 0.1-15 |
| hydrocarbon quenching agent) | |
| Moisture scavenging agent | 0.1-1 |
| Reinforcing extender | 0.1-20 |
| Thixotropic agent | 0.1-20 |
| Pigment | 0-1 |
| Second catalyst (e.g. amine catalyst) | 0.05-2 |
| (added to mixture prior to applying coating) | |

In some embodiments, the desired combination of reactivity and hardness properties of the slow-cure urethane prepolymer and flexible binder urethane prepolymer mixture may be achieved by blending the two components, each with its own specific % NCO content. For example, a slow-cure urethane prepolymer with about 15.8% NCO content can be mixed with a flexible binder urethane prepolymer with about 9.7% NCO content to achieve a desired reactivity and hardness properties that result from the blend. In some embodiments, the % weight of the slow-cure urethane prepolymer is about 10 to 20%, about 20 to 30%, about 30 to 40%, about 40 to 50%, about 50 to 60%, or about 60 to 70%. In other embodiments, the % weight of the flexible binder urethane prepolymer is about 10 to 15%, about 15 to 20%, or about 20 to 30%.

Modifying the ratio between the slow-cure urethane prepolymer and the flexible binder urethane prepolymer may allow for varied application and substrate suitability. For example, in some embodiments, the weight ratio of the flexible binder urethane prepolymer to the slow-cure urethane prepolymer is about 7:10. In some embodiments, the weight ratio of the flexible binder urethane prepolymer to the slow-cure urethane prepolymer is greater than about 7:10, for example about 4:5, 9:10, 1:1, 6:5, 3:2, etc. Such an increase over the 7:10 ratio may increase flexibility and elongation. In some embodiments, high ratios of flexible binder urethane prepolymer to slow-cure urethane prepolymer (e.g., greater than about 7:10) provides a dry film suitable for use with flooring substrates that demonstrate dimensional properties of expansion and contraction. A softer or more flexible product may also function as a sound abatement system (e.g., for wood flooring installations). In some embodiments, the ratio of the flexible binder urethane prepolymer to the slow-cure urethane prepolymer is less than about 7:10, for example about 3:5, 1:2, 2:5, 3:10, 1:5, 1:10, etc. Such a decrease below the 7:10 ratio may reduce flexibility and may increase modulus and/or reduce elastic deformation. In some embodiments, the slow-cure urethane prepolymer can comprise urethane, silane, carboxylate, epoxies, polyesters, phenolics, the like, or a combination thereof. The prepolymers are not limited to the aforementioned examples.

In some embodiments, the slow-cure urethane prepolymer can have an NCO content of about 15 to 19%, or about 17 to 21%, or about 19 to 23%. In other embodiments, the flexible binder urethane prepolymer can have an NCO content of about 2 to 5%, or about 4 to 8%, or about 7 to 10%.

Alternatively, a single urethane prepolymer (a custom prepolymer) (e.g., with a % NCO content similar to the resulting % NCO content of the two-component urethane prepolymer mixture, or with a % NCO content less than or greater than the resulting % NCO content of the two-component urethane prepolymer mixture) could be used to achieve a desired reactivity and hardness properties. For example, a urethane prepolymer with a % NCO content of about 12% NCO could have workable reactivity and hardness properties, thereby eliminating the need to blend two separate components. The percent weight of the urethane prepolymer can be about 10 to 20%, about 20 to 30%, about 30 to 40%, about 40 to 50%, about 50 to 60%, about 60 to 70%, or about 70 to 85%. In other embodiments, the urethane prepolymer can have an NCO content of about 7 to 10%, or about 10 to 15%, or about 15 to 18%, or about 18 to 23%.

Altering the ratio to incorporate more of higher functionality urethane creates hard setting adhesives suitable for applications including masonry, concrete anchoring, and concrete laminates. Due to the hydrophobic silanol-bridge bonding mechanism, the adhesive composition exhibits excellent exterior stability to changes in humidity and temperature. Harder setting variants of the formulation provide maximum bond strengths to flexible substrates.

Rubber flooring materials exhibit flexibility and excellent wear properties, but may be susceptible to effects associated with osmotic activity. Rubber has low vapor permeability. When coupled with sub slab moisture vapor emissions, vapor may condense at the bond line between flooring and concrete (which can ultimately cause osmotic blister formation). The coating composition provides a hydrophobic bond line that repels liquid moisture effectively preventing osmotic events.

Components of the coating may be mixed in sequence (e.g., under high speed dispersion, in an open tank configuration, etc.). In some embodiments, external humidity levels can range from 50 to 100%, i.e. 70%. As used herein, the CRC Publishing's Coatings Technologies Handbook 3rd Edition defines high speed dispersion as a type of mixing wherein solids are dissolved in a liquid by suctioning the solid and liquid mixture into a disc rotating at high speeds. High speed dispersion is known to one of ordinary skill in the art.

Flooring materials may be modified to promote chemical bonds and increase adhesive strength. Without wishing to limit the present invention to any theory or mechanism, it is believed that incorporating adhesion promoters in the composition of the flooring material backing may improve the performance and moisture resistance of the flooring material. In combination with the waterproof coating and degassing primer, the flooring material may better resist the effects of elevated moisture exposure, creating a waterproof flooring installation. The coating may function to mitigate the moisture alone and develop a permanent waterproof bond in concert with the modified flooring material. The hydrophobic nature of the flooring material coupled with magnetic properties may provide an “all-in-one” moisture mitigation/magnetic solution to flooring installation.

In some preferred embodiments, the coatings of the present invention have the ability to attenuate sound, e.g. noise abatement, on par with existing noise reduction underlayments. As used herein, Sound Transmission Class (STC) is an ASTM E90 measurement of the amount of sound transmitted through the floor, for example, noise from an upstairs TV. Impact Insulation Class (IIC) is an ASTM E492 measurement of the amount of sound transferred by impact to the floor, for example, the sound from high heels. To illustrate, a material would require an STC of 30-35 to make normal speech sounds inaudible, an STC of 40-45 to make loud speech sounds inaudible, and an STC of 50-55 to make shouting sounds inaudible. Thus, to reduce noise transfer from room to room, the material would require higher STC values. To meet code requirements, Section 1207 of International Building Code 2006 states that separation between dwelling units, and between dwelling units and public and service areas, must achieve STC 50 (STC 45 if field tested) and IIC 50 for both airborne and structure-borne.

Acoustic testing of the Aquaflex® proceeded as follows: The testing was conducted on a 6″ concrete floor slab with ceiling assembly. Select luxury vinyl planks Royal Maple 3 mm, 6″×36″ planks, herein referred to as LVT, were used as flooring material for testing. A sheet of 2 mil polyethylene plastic was adhered to the floor slab with spray adhesive. The LVT planks were adhered to the plastic sheeting using the Aquaflex® Waterproof Flooring Adhesive, which was spread using a 0.79 mm×1.59 mm×3.57 mm U-notched trowel. The adhesive was trowelled per specifications. The floor/ceiling assembly was installed in a steel test frame, which was installed onto an opening between a source and receiving room in a test chamber. The test frame was isolated from the structure with a dense neoprene gasket.

Both the ASTM E90 (STC) and ASTM E492 (IIC) test protocols were performed. Microphones were calibrated before conducting tests. Airborne transmission loss test (STC) was conducted in accordance with the ASTM E90 test method using the single direction method. Two background noise sound pressure level and five sound absorption measurements were conducted at each of the five microphone positions. Four sound pressure level measurements were made simultaneously in both rooms, at each of the five microphone positions. Impact sound transmission test (IIC) was conducted in accordance with the ASTM E492 test method. Two background noise sound pressure levels, two sound pressure level measurements with a tapping machine operating at each position specified by ASTM E492, and five sound absorption measurements were conducted at each of the five microphone positions.

As shown in TABLE 17, the acoustic testing of the Aquaflex® adhesive resulted in an STC value of 62 and IIC value of 57. These results were surprising considering a trowel with 9/64″ U-notch spread was used, as compared to typical LVT adhesives using a 1/32″ square notch spread (almost 2× the amount of adhesive). These results prove that the Aquaflex® adhesive, by itself and without underlayment, can attenuate sound in both ASTM protocols comparable to systems of acoustical underlayment with conventional adhesives. More importantly, these results exceed the IBC Code 2006 for noise abatement.

TABLE 17

| Product | Description | STC | IIC |
|---|---|---|---|
| LVT w/conventional | w/o underlayment | 25-30 | 35-40 |
| adhesive | | | |
| LVT w/Iso-Step Floor | 2 mm, recycled rubber | 63 | 50 |
| Underlayment | (Acoustical Solutions) | | |
| LVT w/Armstrong Quiet | 1 mm, Polypropylene | 62 | 64 |
| comfort | foam w/poly film | | |
| LVT w/SolidWalk | 3.2 mm, synthetic fiber | 54 | 58 |
| LT-Fiber MB | blend w/poly film | | |
| LVT w/TrafficMASTER | 3.2 mm, synthetic fiber | 54 | 60 |
| Acoustical | w/poly film | | |
| LVT w/The Silencer | 1.5 mm, high-density | 68 | 73 |
| LVT | polyurethane foam w/poly film | | |
| LVT w/attached cork | COREtec Plus-8 mm total | 62 | 62 |
| | thickness (1.5 mm cork) | | |
| LVT w/Aquaflex | Aquaflex adhesive using | 62 | 57 |
| | 9/64″ U-notch trowel | | |

### Method of Producing Coatings

Another embodiment of the present invention features a method of producing a curable pressure sensitive, magnetic, waterproof coating mixture. The method providing a urethane component, providing a first silane component, providing a reinforcing extender, providing a magnetic agent, providing a thixotropic agent, mixing the urethane component, the first silane component, the reinforcing extender, the magnetic agent, and the thixotropic agent to form a dispersion, adding a second silane component to the dispersion, and mixing the second silane component and the dispersion to form the coating mixture. Without wishing to limit the invention to a particular theory or mechanism, the method can be effective for producing the coating mixture that, when applied to substrate, has a tack-free time of at least about 90 minutes. Further still, the coating mixture can be waterproof, hydrolytically stable, and pH-resistant.

In one embodiment, the urethane component may be at a range of about 30-50 wt % of the mixture. In another embodiment, the urethane component can have an average NCO content of about 7 to 23%.

In some embodiments, the urethane component may comprise at least one urethane selected from a group consisting of a slow-cure urethane having a functionality (Fn) of about 2.5 to 2.55 and an NCO content of about 15 to 23%, and a flexible binder urethane having a functionality (Fn) of about 2 and an NCO content of about 2 to 10%. In other embodiments, the method may further comprise adding a polyol, such as polypropylene glycol or polyether polyol, or an alkoxy functionalized silicone polymer, as a substitute of the flexible binder urethane or the slow-cure urethane.

In one embodiment, the first silane component may be an amino-functional alkoxysilane polymer having terminal silanol groups. In another embodiment, the first silane component may be at a range of about 2-10 wt % of the mixture. In some embodiments, the reinforcing extender may be at a range of about 2-10 wt % of the mixture. In other embodiments, the thixotropic agent may be at a range of about 2-10 wt % of the mixture. In still other embodiments, the magnetic agent may be at a range of about 0.1-20 wt % of the mixture.

In some embodiments, the second silane component may comprise a methylethylketoximino (MEKO) silane according to the formula:

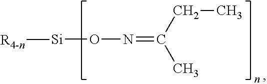

where n ranges from 1 to 4, and R is an alkyl, an alkene, or aryl group. In preferred embodiments, the MEKO silane may be a methyl tris(MEKO)silane, a phenyl tris(MEKO)silane, a vinyl tris(MEKO)silane, a tetrakis(MEKO)silane, a dimethyl bis(MEKO)silane, or a combination thereof. In other embodiments, the second silane component may be at a range of about 2-10 wt % of the mixture.

In one embodiment, the method may further comprise adding about 15-40 wt % of a polyol component having an average molecular weight of at least about 4,000 g/mol to the dispersion, and mixing prior to adding the second silane component. In another embodiment, the method may further comprise adding about 5-15 wt % of an aliphatic quencher to the dispersion and mixing prior to adding the second silane component. In yet another embodiment, the method may further comprise adding about 2-10 wt % of a tackifier to the dispersion and mixing prior to adding the second silane component.

In some embodiments, the method may further comprise further adding and mixing carbon nanofibers into the dispersion. The carbon nanofibers may be effective for increasing electrical conductivity of the coating composition. In some embodiments, each carbon nanofiber can have a fiber diameter of about 120 to 160 nm, and a dispersive surface energy of about 120 to 140 mJ/m². Without wishing to limit the invention to a particular theory or mechanism, the carbon nanofibers can provide enhanced electrical conductivity over a broad range along with mechanical reinforcement of the coating. Other benefits provided by the carbon nanofibers include improved heat distortion temperatures and increased electromagnetic shielding.

In other embodiments, the method may further comprise adding and mixing an inherently static dissipative (IDP) component into the dispersion. The IDP component may be effective for decreasing surface resistance of the coating mixture. Other benefits of the IDP component include the ability to ground potentially hazardous charges. The IDP component can have a surface resistivity of about 1⁰⁷ to 1¹⁰ Ω/sq. Non-limiting examples of the IDP component include polypropylene, polystyrene, polyethylene, and acrylic polymers.

In some embodiments, the urethane prepolymer may be dispersed in a solvent comprising a fatty acid ester component, where the solvent homogeneously disperses the urethane prepolymer. In other embodiments, the method further comprises adding a silane. In some embodiments, the wt ratio of a fatty acid component to the urethane prepolymer is 10 to 20:40 to 80. In other embodiments, the ratio of the fatty acid component to the urethane prepolymer is 14 to 16:40 to 50. In other embodiments, the ratio of the fatty acid component to the urethane prepolymer is 14 to 16:65 to 75. In further embodiments, the ratio of the fatty acid component to the urethane prepolymer is 14.5:44. In still further embodiments, the ratio of the fatty acid component to the urethane prepolymer is 14.5:71.5.

In some embodiments, the coating mixture is produced at a relative humidity of at least 1%. As understood by one of ordinary skill, the relative humidity is the ratio of the parti d pressure of water vapor in an air-water mixture to the satorated vapor pressure of water at a given temperature. In some embodiments, the method can be performed at a relative humidity of about 1% to 20%, about 20% to 40%, about 40%-60%, about 60% to 80%, or about 80% to 100%. Preferably, the method can be performed at any level of relative humidity without requiring vacuum conditions and without adverse effects on the coating.

### Coating Applications

It is a further objective of the present invention to provide for methods of using the coating. In some embodiments, the present invention features a method of adhering a first substrate to a second substrate. In some embodiments, the method may comprise providing any of the coating mixtures described herein, applying the coating mixture to a surface of a first substrate to form an magnetic coating on the surface, applying a magnetic second substrate to the magnetic coating after at least about 60 minutes, thereby magnetically attaching the first substrate and the second substrate together.

In other embodiments, the invention features a method of installing a flooring material to a floor substrate. The method may comprise providing any of the coating mixtures described herein, applying the coating mixture to a surface of the floor substrate to form a magnetic coating on the surface, applying the magnetic flooring material to the coating after at least about 60 minutes after forming the coating, thereby magnetically attaching the flooring material to the floor substrate.

In another embodiment, the invention features a method of providing a magnetic coating for a surface. The method may comprise providing any of the magnetic coating mixtures applied herein to the surface to form a coating on the surface, and curing the coating for at least 30 minutes. This magnetic coating may be used to affix materials to the surface using magnetic force.

In other embodiments, the present invention features a waterproof adhesive coating kit. The kit comprises a deactivated adhesive composition comprising a silane end-capped polymer component comprising a silane and a urethane component, wherein the urethane component comprises a flexible binder urethane prepolymer, a slow-cure urethane, or both, a first catalyst, a reinforcing extender, one or more thixotropic agents, an anti-skinning agent, and a second catalyst that is kept separate from the deactivated adhesive composition. The second catalyst is added to the deactivated adhesive until a substrate is ready to be coated with an adhesive. The second catalyst is preferably an amine catalyst.

In yet another embodiment, the present invention features a method of coating a substrate with an adhesive. The method may comprise, providing a deactivated adhesive composition for coating a substrate, adding the second catalyst to the first composition to form an adhesive composition prior to coating the substrate, and coating the substrate with the adhesive composition. The adhesive composition may comprise a first composition comprising a silane end-capped polymer component comprising a silane and a urethane component, wherein the urethane component comprises a flexible binder urethane prepolymer, a slow-cure urethane, or both, a first catalyst, a reinforcing extender, one or more thixotropic agents, and an anti-skinning agent and a second catalyst that is kept separate from the first composition.

### Moisture Vapor Suppressants

As used herein, the term “moisture vapor suppressant”, abbreviated as “MVS”, may be interchangeably referred to as “Aquaflex® MVS”.

As will be further described herein, the MVS polymer compositions of the present invention features a non-silicate, reactive urethane chemistry that penetrates, impregnates and polymerizes “intrinsically” or within the concrete surface to form a new densified concrete/plastic matrix. This novel intrinsic structure restricts capillary activity, reducing moisture vapor emissions rates by up to 80% per ASTM E-96 (Test Method for Water Vapor Transmission of Materials, Permeability). Also, the polymer composition does not form a topical film subject to possible blistering like epoxy from migration of soluble silicates found contained within the concrete interior. The polymer composition is safe, non-flammable, odorless, contains bio-based materials, and has 0 (zero) VOC. Further still, the composition is self-priming and functions universally with all water-based adhesives. It can instantly extend the performance of any standard manufacturer supplied adhesive allowing application over concrete exhibiting up to 95% in situ RH per ASTM F-2170 and/or 12 lbs MVER per ASTM F-1869.

According to other embodiments, the present invention also features magnetic polymer compositions for suppressing moisture vapor emissions in a concrete substrate by penetrating and polymerizing within the surface of the concrete substrate to form a densified concrete and plastic matrix.

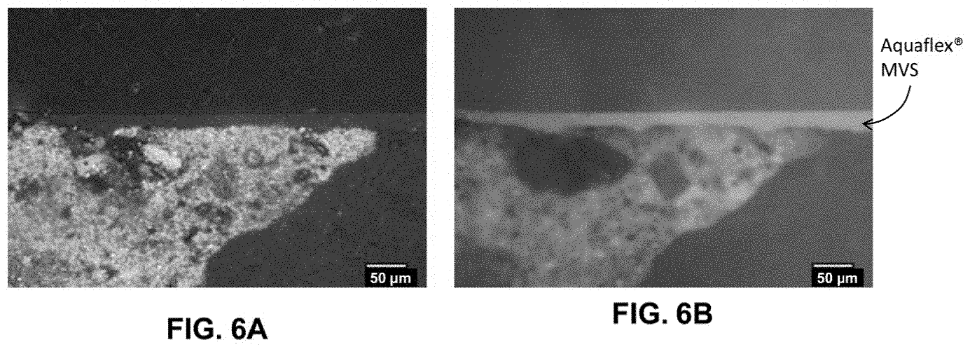

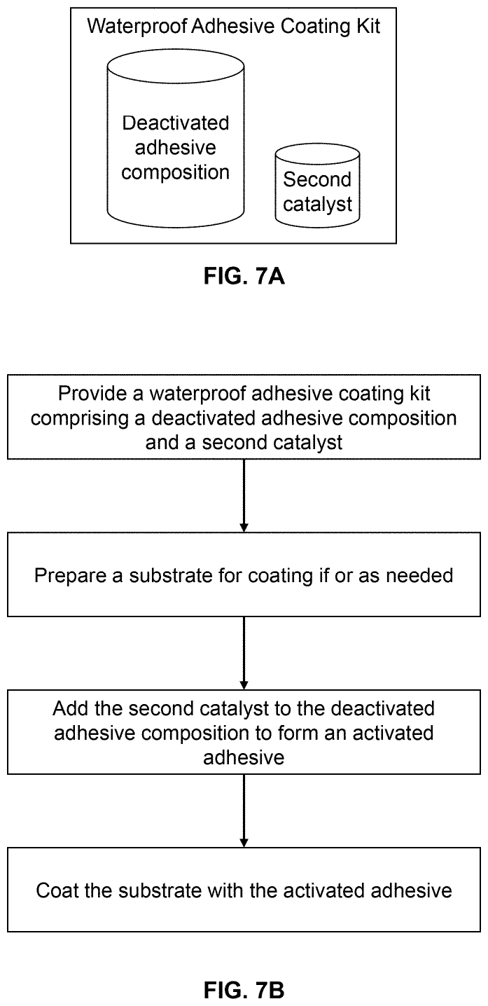

Referring now to FIGS. 6A-6B, the present invention features an MVS prepolymer composition for suppressing moisture vapor movement in a concrete substrate. In one embodiment, the composition may comprise a polyisocyanate component, one or more thinning components, a wetting and leveling component, a tackifier, and a catalyst. Without wishing to limit the invention to a particular theory or mechanism, when the prepolymer composition is applied to a concrete surface of the concrete substrate, the prepolymer composition can penetrate and polymerize within the concrete surface of the concrete substrate to form a densified concrete and plastic matrix, as shown in FIG. 6B. The densified concrete and plastic matrix are effective to reduce a porosity of the concrete surface or near-surface region, thereby restricting movement of moisture vapor, which is disposed within the concrete substrate, to the concrete surface.

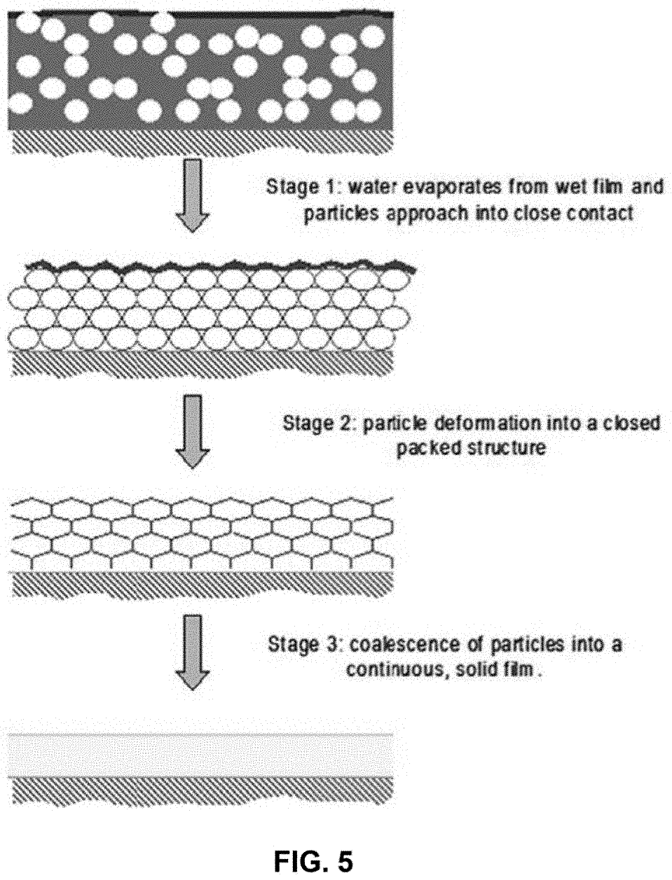

The process by which polymer solutions turn into solid continuous films can be simplified as a series of events occurring during three main stages, as shown in FIG. 5. During the first stage, water evaporates from the film while particles come into close contact. The second stage is characterized by deformation of particles into a closed packed structure. In the third stage, individual entities are no longer defined due to sintering of particles into a solid, continuous film strengthened by inter-diffusion of chain segments.

In some embodiments, the MVS prepolymer composition may comprise about 10-90% vol of the polyisocyanate component. In other embodiments, the polyisocyanate component is at a range of about 10-30% vol of the composition. In other embodiments, the polyisocyanate component is at a range of about 30-50% vol of the composition. In other embodiments, the polyisocyanate component is at a range of about 50-70% vol of the composition. In other embodiments, the polyisocyanate component is at a range of about 70-90% vol of the composition.

In one embodiment, the polyisocyanate component may comprise an aliphatic polyisocyanate. For instance, the aliphatic polyisocyanate component may comprise a dimeric hexamethylene diisocyanate and a monomeric hexamethylene diisocyanate. The polyisocyanate component may have an NCO content of about 20-25%. In some embodiments, as shown in the reaction scheme below, a short-chain biuret may be produced by reacting isocyanates and amines to yield polyurea, and then reacting the polyurea with isocyanates.

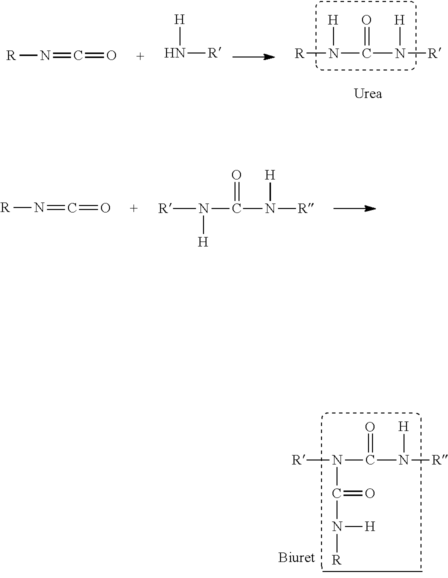

In one embodiment, the MVS prepolymer composition may comprise about 10-70% vol of the one or more thinning components. In another embodiment, the one or more thinning components are at a range of about 10-30% vol of the composition. In yet another embodiment, the one or more thinning components are at a range of about 30-50% vol of the composition. In a further embodiment, the one or more thinning components are at a range of about 50-70% vol of the composition.

In one embodiment, the one or more thinning components are used as solvents, which may be aliphatic esters and aliphatic ketones such as ethyl acetate, butyl acetate, methoxy propyl acetate, acetone, methyl ethyl ketone, methyl isobutyl ketone, cyclohexanone. In some embodiments, the thinning component may comprise propylene carbonate. In another embodiment, the one or more thinning components are aromatic hydrocarbons such as toluene, xylene, solvent naphtha 100 and mixtures thereof. In some embodiments, the one or more thinning components may comprise a halogenated aromatic component, such as para-chlorobenzotrifluoride.

In some embodiments, the MVS prepolymer composition may comprise about 0.05-1% vol of the wetting and leveling component. In other embodiments, the wetting and leveling component may be about 0.05-0.1% vol of the composition, or about 0.1-0.5% vol of the composition, or about 0.5-1% vol of the composition. In some embodiments, the wetting and leveling component may comprise a fluorocarbon modified polymer. The fluorocarbon modified polymer can act as a defoamer, a deaerator, a surface leveler and a surface wetter.

In some embodiments, the MVS prepolymer composition may comprise about 5.0-10.0% vol of the tackifier. For example, the tackifier may be about 5.0-7.0% vol of the composition, or about 7.0-9.0% vol of the composition, or about 9.0-10.0% vol of the composition. In some embodiments, the tackifier may comprise methyl ester of rosin. Without wishing to limit the invention to a particular theory or mechanism, the tackifier can modify a surface of the densified concrete and plastic matrix for priming the surface in order to promote inter-coat adhesion with a secondary material, such as a coating or adhesive. For example, the tackifier is effective for tackifying the surface, thereby eliminating further surface modification of the surface of the densified concrete and plastic matrix.

In some embodiments, the MVS prepolymer composition may comprise about 0.1-0.5% vol of the catalyst. For instance, the catalyst may be about 0.1-0.25% vol of the composition. In another embodiment, the catalyst may be about 0.25-0.4% vol of the composition or about 0.4-0.5% vol of the composition. In an exemplary embodiment, the catalysts may be a metal salt catalyst, such as dibutyltin dilaurate. Without wishing to limit the invention to a particular theory or mechanism, the catalyst is effective for increasing the polymerization rate of the prepolymer composition.

In some embodiments, the MVS prepolymer composition may comprise about 0.1-1% vol of a magnetic agent. In another embodiment, the magnetic agent may be about 1-2, 2-3, 3-4, 4-5, 5-6, 6-7, 7-8, 8-9, 9-10, 10-12, 12-14, 14-16, 16-18, 18-20 or above 20% vol of the composition. In an exemplary embodiment, the magnetic agent may be ferrite, iron, iron filings, or ferrous oxide.

In alternative embodiments, the MVS prepolymer composition may further comprise a silyl-terminated polyether at a range of about 1-90% vol of the composition. In some embodiments, the silyl-terminated polyether is at a range of about 1-20% vol of the composition, or at a range of about 20-40% vol of the composition, or at a range of about 40-60% vol of the composition, or at a range of about 60-80% vol of the composition. In further embodiments, the silyl-terminated polyether is at a range of about 80-90% vol of the composition.

As known to one of ordinary skill in the art, a silyl modified polymer (SMP) is a polymer having a terminal silyl group. According to some embodiments, the silyl-terminated polyether may be a silyl-terminated polyethylene glycol or a silyl-terminated polypropylene glycol. However, any silyl-terminated polyether may be used with the present invention. The silyl-terminated polyethers cure by crosslinking of the silyl ethers via hydrolysis, which generates a siloxane linkage. The silyl-terminated polyethers may be used as a raw material polymer, and formulated with various plasticizers, fillers, and other additives. The silyl-terminated polyethers can be cured at ambient temperature, and offer low viscosity, good storage stability, good durability, low specific gravity, and good adhesion to various substrates. In alternative embodiments, SMPs, such as the silane modified polyether, may be used in combination with the polyisocyanate component, or may be used to replace the polyisocyanate component.

In some embodiments, the MVS prepolymer composition may further comprise a fluorescent dye tracer at a range of about 0.01-1.0% vol of the composition. The fluorescent dye tracer is added based upon high strength, solvent soluble optical brighteners having either coumarin or benzoxazole organic structure, suitable for use in non-destructive testing applications. The optical brighteners are readily soluble in most solvent systems and the fluorescence of the dye allows for easy detection when the dye is excited by the use of a UV light. The tracer can track the penetration of the polymer composition in order to determine if the composition is applied or properly applied.

In some embodiments, the MVS prepolymer composition may further comprise a color indicator. Without wishing to limit the invention to a particular theory or mechanism, the color of the color indicator disappears upon cure of the polymer composition to the concrete substrate thereby indicating penetration within the concrete surface and formation of the densified concrete and plastic matrix.

In preferred embodiments, the MVS prepolymer composition has a viscosity that is less than 500 centipoise at ambient temperature (23° C.). In more preferred embodiments, the MVS prepolymer composition has a viscosity that is less than 100 centipoise at 23° C. In some preferred embodiments, the MVS prepolymer composition has a viscosity lower than water viscosity at ambient temperature.

As used herein, “fully cured” is defined as when the MVS prepolymer composition has reached at least 90% polymerization. In a preferred embodiment, the densified concrete and plastic matrix is fully cured (>90%) within 180 minutes after applying the prepolymer composition to the concrete surface. In a more preferred embodiment, the densified concrete and plastic matrix is fully cured (>90%) within 90 minutes after applying the MVS prepolymer composition to the concrete surface. Without wishing to limit the invention to a particular theory or mechanism, the composition is self-priming when applied to the concrete substrate, thus the cured composition does not require or need a primer coating in order to facilitate adhesion to a secondary material. Preferably, the surface of the cured composition can provide the necessary surface properties in order to promote inter-coat adhesion.

In a preferred embodiment, the MVS prepolymer composition is volatile organic compound (VOC) exempt, unlike the water-based polymeric products which typically require the addition of a coalescing solvent for film formation. For example, the composition may have a VOC value of 0. As such, the MVS prepolymer compositions of the present invention provide an excellent environmental profile. In another preferred embodiment, the MVS prepolymer composition forms an extremely hard plastic matrix within the concrete substrate. For instance, the prepolymer composition, when cured, has a hardness greater than about 95 in a durometer type D scale.

According to another embodiment, the present invention features an MVS polymer composition for suppressing moisture vapor movement in a concrete substrate. In one embodiment, the composition may comprise a cured product of any of the MVS prepolymer compositions described herein. For example, the MVS polymer composition may comprise a cured product of a polyisocyanate component at a range of about 10-90% vol of the composition, one or more thinning components at a range of about 10-70% vol of the composition, a wetting and leveling component at a range of about 0.05-1% vol of the composition, a tackifier at a range of about 5.0-10.0% vol of the composition, and a catalyst at a range of about 0.1-0.5% vol of the composition. In some embodiments, the MVS polymer composition may further comprise a silyl-terminated polyether at a range of about 1-90% vol of the composition. Without wishing to limit the invention to a particular theory or mechanism, the MVS polymer composition is effective to form a densified concrete and plastic matrix when applied to a concrete surface of the concrete substrate. Preferably, the densified concrete and plastic matrix is effective to reduce a porosity of the concrete surface, thereby restricting movement of moisture vapor from within the concrete substrate to the concrete surface.

According to yet another embodiment, the present invention features a method of producing a prepolymer primer material for suppressing moisture vapor movement in a concrete substrate. The method may comprise providing about 10-90% vol of a polyisocyanate component, about 10-70% vol of one or more thinning components, about 0.05-1% vol of a wetting and leveling component, about 5.0-10.0% vol of a tackifier, and about 0.1-0.5% vol of a catalyst; and mixing the polyisocyanate component, the one or more thinning components, the wetting and leveling component, the tackifier, and the catalyst to produce the prepolymer primer material.

In other embodiments, the present invention features a method of suppressing moisture vapor movement in a concrete substrate. The method may comprise providing a primer material comprising any of the MVS prepolymer compositions described herein, applying the primer material to a surface of the concrete substrate, in which the primer material intrinsically modifies the concrete substrate by penetrating into the concrete substrate and polymerizing to form a densified concrete and plastic matrix, and curing the densified concrete and plastic matrix for a period of time. As a result, the densified concrete and plastic matrix reduces a porosity of the concrete surface, thereby restricting movement of moisture vapor from within the concrete substrate to the concrete surface.

The MVS prepolymer composition is safe to handle, functions universally with all flooring adhesives to reduce moisture vapor emission rates up to 80% and blocks the negative hydrolytic effects of elevated concrete source pH/moisture on secondary adhesives or coatings. For example, the MVS polymer composition may be used in combination with the Aquaflex® adhesive compositions described herein. While the Aquaflex® adhesive is in itself waterproof, the MVS polymer composition can work symbiotically to reduce exposure of the Aquaflex® adhesive to moisture vapor. In preferred embodiments, the MVS polymer composition does not form a topical film subject to blistering like epoxy. Furthermore, it can have a shelf life of one year.

The MVS prepolymer composition is effective with any adhesive chemistry. Standard supplied adhesives will instantly exhibit performance thresholds suited for application over concrete with measured moisture vapor emission rates (MVER) of 12 lbs per ASTM F-1869 and in-situ RH of up to 95% per ASTM F-2170. The ASTM F-1869 test method is used to obtain a qualified value indicating the rate of moisture vapor emission from the surface of a concrete floor. All concrete subfloors emit an amount of moisture in vapor or gaseous form. Concrete moisture emission is a natural process driven by environmental conditions such as ambient temperature and humidity, sub-slab moisture content and cement mix design. Floor coverings are susceptible to failure of their respective adhesive systems due to exposure of elevated pH/moisture derived from excessive moisture vapor emissions. The moisture vapor emitted from a concrete slab is measured, in pounds, as the equivalent weight of water evaporating from 1000 ft² of concrete surface in a 24 hr period. Often referred to as the calcium chloride moisture test, this test has been the industry standard for determination of dynamic concrete moisture. The results obtained reflect the condition of the concrete floor surface at the time of testing and may not indicate future conditions. The ASTM F-2170 in-situ concrete moisture test places sensors, or probes, inside the slab itself. As concrete dries, moisture migrates from the bottom of the slab to the surface where it can evaporate away. Logically then, moisture levels at the bottom of a slab will read higher from those at the surface. In-situ probes provide relative humidity (RH) measurements at 40% of the slab's depth, a position proven to more accurately portray the final RH levels of the slab if it were to be sealed at that point in time and the slab moisture allowed to fully equilibrate. In this way, in situ measurement provides a composite picture of overall slab moisture levels and provides the data necessary to make business decisions regarding flooring installations and potential for flooring adhesive failure.

### EXAMPLES

The following are presented as non-limiting examples of the present invention. It is to be understood that the examples in no way limit the invention, and that equivalents or substitutes are within the scope of the invention.

### Example 1

The following is a non-limiting example of a method of producing the adhesive composition. Components of the adhesive may be mixed in sequence (e.g., under high speed dispersion, in an open tank configuration, etc.).
1. Add 50% wt. (by weight of total formulation) slow-cure urethane prepolymer with 15.8% NCO content.
2. Add and continuously blend 30% wt. flexible binder urethane prepolymer with 9.7% NCO content.
3. Add and continuously blend 1.5% wt. gamma-aminopropyltrimethoxysilane.
4. Add and continuously blend 0.1% wt. dibutyltin dilaurate to catalyze the reaction.
5. Allow components 1-4 to blend thoroughly (approximately 15-20 minutes).
6. Add and continuously blend 10% wt. mixture of aliphatic fatty acid ester (non-petroleum base) to quench the urethane reaction.
7. Add and continuously blend 0.7% wt. vinyltrimethoxysilane to scavenge potential atmospheric humidity (from open tank configuration).
8. Add and continuously blend 15% wt. surface-treated natural calcium carbonate reinforcing extender to add body to the formulation and build viscosity.
9. Add and continuously blend 15% wt. surface treated fumed silicate to achieve “high viscosity with low shear, and low viscosity with high shear” appropriate for trowel application.
10. Add and continuously blend 0.35% wt. 3-glycidoxypropyltrimethoxy-silane.
11. Add and continuously blend 0.2% wt. pigment to achieve desired aesthetics.

### Example 2

The following is another non-limiting example of a method of producing the adhesive composition. Components of the adhesive may be mixed in sequence (e.g., under high speed dispersion, in an open tank configuration, etc.).
1. Add 40% wt. (by weight of total formulation) slow-cure urethane prepolymer with 16% NCO content. In some embodiments, the slow-urethane prepolymer has a % NCO content between about 5% to 25%.
2. Add 1% wt. (by weight of total formulation) slow-cure urethane prepolymer with 22% NCO content. In some embodiments, the slow-urethane prepolymer has a % NCO content between about 15% to 35%.
3. Add and continuously blend 26% wt. polyether polyol tackifier.
4. Add and continuously blend 1% wt. gamma-aminopropyltrimethoxysilane.
5. Add and continuously blend 0.2% wt. dibutyltin dilaurate to catalyze the reaction.
6. Allow components 1-5 to blend thoroughly (approximately 15-20 minutes).
7. Add and continuously blend 14.5% wt. mixture of aliphatic fatty acid ester (non- petroleum base) to disperse the urethane prepolymer and quench the urethane reaction.
8. Add and continuously blend 0.3% wt. vinyltrimethoxysilane to scavenge potential atmospheric humidity (from open tank configuration).
9. Add and continuously blend 9% wt. surface-treated natural calcium carbonate reinforcing extender to add body to the formulation and build viscosity.
10. Add and continuously blend 3% wt. surface treated fumed silicate to achieve “high viscosity with low shear, and low viscosity with high shear” appropriate for trowel application.
11. Add and continuously blend 1.5% wt. methyl ester of rosin, to plasticize the adhesive and/or reduce moisture sensitivity and/or enhance flexibility and adhesion to low energy flooring substrates.
12. Add and continuously blend 0.5% wt. pigment to achieve desired aesthetics.

### Example 3

The following is another non-limiting example of a method of producing the adhesive composition. Components of the adhesive may be mixed in sequence (e.g., under high speed dispersion, in an open tank configuration, etc.).
1. Add 43.5% wt. (by weight of total formulation) slow-cure urethane prepolymer with 16% NCO content. In some embodiments, the slow-urethane prepolymer has a % NCO content between about 5% to 25%.
2. Add and continuously blend 18% wt. flexible binder urethane prepolymer with 9.7% NCO content. In some embodiments, the flexible binder urethane prepolymer has a % NCO content between about 5% to 15%.
3. Add and continuously blend 1% wt. gamma-aminopropyltrimethoxysilane.
4. Add and continuously blend 0.1% wt. dibutyltin dilaurate to catalyze the reaction.
5. Allow components 1-4 to blend thoroughly (approximately 15-20 minutes).
6. Add and continuously blend 14.5% wt. mixture of aliphatic fatty acid ester (non-petroleum base) to disperse the urethane prepolymer and quench the urethane reaction.
7. Add and continuously blend 0.4% wt. vinyltrimethoxysilane to scavenge potential atmospheric humidity (from open tank configuration).
8. Add and continuously blend 9% wt. surface-treated natural calcium carbonate reinforcing extender to add body to the formulation and build viscosity.
9. Add and continuously blend 0.5% wt. pigment to achieve desired aesthetics.

### Example 4

The following is a non-limiting example of a method of producing the adhesive composition. Components of the adhesive may be mixed in sequence (e.g., under high speed dispersion, in an open tank configuration, etc.).
1. Add 55-70% wt. (by weight of total formulation) slow-cure urethane prepolymer with 16% NCO content.
2. Add and continuously blend 15-30% wt. flexible binder urethane prepolymer with 9.7% NCO content.
3. Add and continuously blend 0.01-1.5% wt. gamma-aminopropyl trimethoxy-silane.
4. Add and continuously blend 0.001-0.01% wt. dibutyltin dilaurate to catalyze the reaction.
5. Add and continuously blend 5-10% wt. mixture of aliphatic fatty acid ester to disperse the urethane prepolymer and quench the urethane reaction.
6. Add and continuously blend 0.01-0.05% wt. vinyltrimethoxysilane to scavenge potential atmospheric humidity.
7. Add and continuously blend 3-10% wt. hydrophobically-modified reinforcing extender to add body to the formulation and build viscosity.
8. Add and continuously blend 1-5% wt. hydrophobically-modified thixotropic agent.
9. Add and continuously blend 0.5-2% wt. methyl ester of rosin.
10. Add and continuously blend 0.5% wt. pigment to achieve desired aesthetics.

### Example 5

The following is another non-limiting example of a method of producing the adhesive composition. Components of the adhesive may be mixed in sequence (e.g., under high speed dispersion, in an open tank configuration, etc.).
1. Add 40-55% wt. (by weight of total formulation) slow-cure urethane prepolymer with 16% NCO content.
2. Add and continuously blend 25-40% wt. polyether polyol.
3. Add and continuously blend 0.01-1.5% wt. gamma-aminopropyltrimethoxysilane.
4. Add and continuously blend 0.001-0.01% wt. dibutyltin dilaurate to catalyze the reaction.
5. Add and continuously blend 5-10% wt. mixture of aliphatic fatty acid ester to disperse the urethane prepolymer and quench the urethane reaction.

6. Add and continuously blend 0.01-0.05% wt. vinyltrimethoxysilane to scavenge potential atmospheric humidity.
7. Add and continuously blend 3-10% wt. hydrophobically-modified reinforcing extender to add body to the formulation and build viscosity.
8. Add and continuously blend 1-5% wt. hydrophobically-modified thixotropic agent.
9. Add and continuously blend 0.5-2% wt. methyl ester of rosin.
10. Add and continuously blend 0.5% wt. pigment to achieve desired aesthetics.

### Example 6

The following is another non-limiting example of a method of producing the adhesive composition. Components of the adhesive may be mixed in sequence (e.g., under high speed dispersion, in an open tank configuration, etc.).
1. Add 10-30% wt. (by weight of total formulation) slow-cure urethane prepolymer with 16% NCO content.
2. Add and continuously blend 40-60% wt. polyether polyol.
3. Add and continuously blend 0.01-1.5% wt. gamma-aminopropyltrimethoxysilane.
4. Add and continuously blend 0.001-0.01% wt. dibutyltin dilaurate to catalyze the reaction.
5. Add and continuously blend 5-10% wt. mixture of aliphatic fatty acid ester to disperse the urethane prepolymer and quench the urethane reaction.
6. Add and continuously blend 0.01-0.05% wt. vinyltrimethoxysilane to scavenge potential atmospheric humidity.
7. Add and continuously blend 3-10% wt. hydrophobically-modified reinforcing extender to add body to the formulation and build viscosity.
8. Add and continuously blend 1-5% wt. hydrophobically-modified thixotropic agent.
9. Add and continuously blend 0.5-2% wt. methyl ester of rosin.
10. Add and continuously blend 0.5% wt. pigment to achieve desired aesthetics.

### Example 7

The following is another non-limiting example of a method of producing the adhesive composition. Components of the adhesive may be mixed in sequence (e.g., under high speed dispersion, in an open tank configuration, etc.).
1. Add 30-50% wt. (by weight of total formulation) urethane prepolymer with 7-23% NCO content.
2. Add and continuously blend 20-40% wt. of polyol.
3. Add and continuously blend 2-8% wt. of amino-functional alkoxysilane.
4. Add and continuously blend 0.01-0.5% wt. dibutyltin dilaurate to catalyze the reaction.
5. Add and continuously blend 8-15% wt. mixture of aliphatic fatty acid ester to disperse the urethane prepolymer and quench the urethane reaction.
6. Add and continuously blend 3-10% wt. hydrophobically-modified reinforcing extender to add body to the formulation and build viscosity.
7. Add and continuously blend 3-10% wt. hydrophobically-modified thixotropic agent.
8. Add and continuously blend 2-7% wt. tackifier.
9. Add and continuously blend 3-10% wt. MEKO silane.
10. Add and continuously blend 0.5% wt. pigment to achieve desired aesthetics.

### Example 8

The following is another non-limiting example of a method of producing the adhesive composition. Components of the adhesive may be mixed in sequence (e.g., under high speed dispersion, in an open tank configuration, etc.).
1. Add 30-50% wt. (by weight of total formulation) urethane prepolymer with 7-23% NCO content.
2. Add and continuously blend 20-40% wt. polypropylene glycol.
3. Add and continuously blend 0.01-1.5% wt. amino-functional alkoxysilane.
4. Add and continuously blend 0.001-0.01% wt. dibutyltin dilaurate to catalyze the reaction.
5. Add and continuously blend 5-10% wt. mixture of aliphatic fatty acid ester to disperse the urethane prepolymer and quench the urethane reaction.
6. Add and continuously blend 0.01-0.05% wt. vinyltrimethoxysilane to scavenge potential atmospheric humidity.
7. Add and continuously blend 3-10% wt. hydrophobically-modified reinforcing extender to add body to the formulation and build viscosity.
8. Add and continuously blend 1-5% wt. hydrophobically-modified thixotropic agent.
9. Add and continuously blend 0.5-2% wt. methyl ester of rosin.
10. Add and continuously blend 3-10% wt. vinyltris(MEKO)silane.
11. Add and continuously blend 0.5% wt. pigment to achieve desired aesthetics.

### Example 9

The following is another non-limiting example of a method of producing the adhesive composition. Components of the adhesive may be mixed in sequence (e.g., under high speed dispersion, in an open tank configuration, etc.).
1. Add 30-50% wt. (by weight of total formulation) urethane prepolymer with 7-23% NCO content.
2. Add and continuously blend 20-40% wt. polyether polyol.
3. Add and continuously blend 0.01-1.5% wt. amino-functional alkoxysilane.
4. Add and continuously blend 0.001-0.01% wt. dibutyltin dilaurate to catalyze the reaction.
5. Add and continuously blend 5-10% wt. mixture of aliphatic fatty acid ester to disperse the urethane prepolymer and quench the urethane reaction.
6. Add and continuously blend 0.01-0.05% wt. vinyltrimethoxysilane to scavenge potential atmospheric humidity.
7. Add and continuously blend 3-10% wt. hydrophobically-modified reinforcing extender to add body to the formulation and build viscosity.
8. Add and continuously blend 1-5% wt. hydrophobically-modified thixotropic agent.
9. Add and continuously blend 0.5-2% wt. methyl ester of rosin.
10. Add and continuously blend 3-10% wt. methyltris(MEKO)silane.
11. Add and continuously blend 0.5% wt. pigment to achieve desired aesthetics.

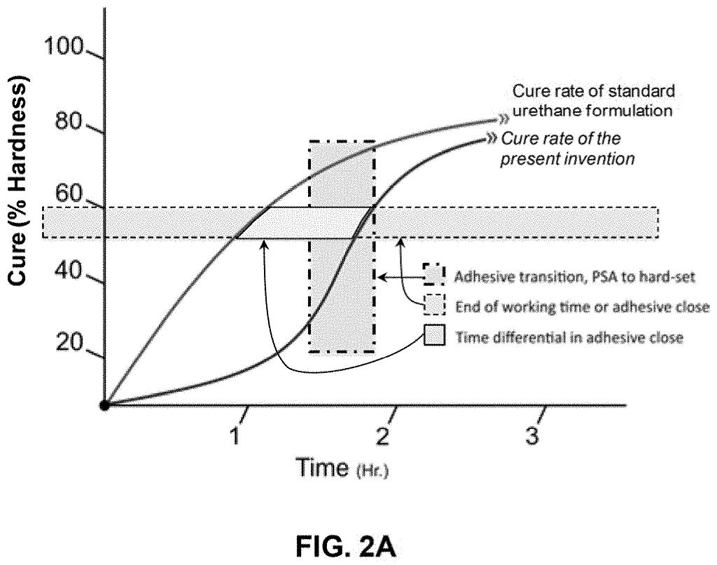

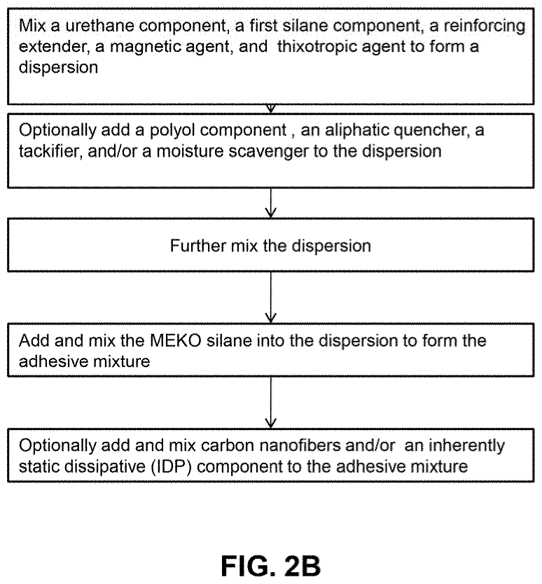

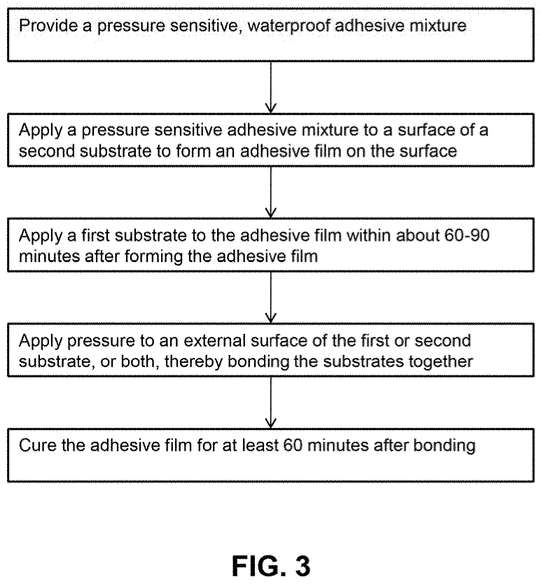

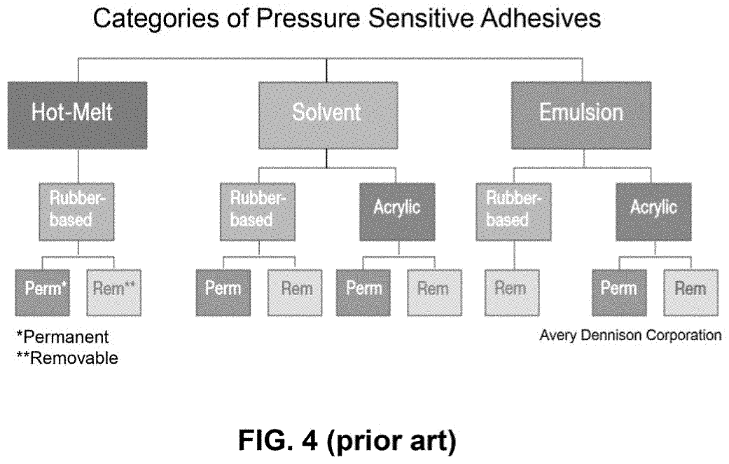

Referring to EXAMPLES 7-9, without wishing to limit the invention to a particular theory or mechanism, it was unexpectedly and surprisingly found that the late (i.e. last or later) addition of the MEKO silane to the formulation appears to suppress the regular cure rate of the adhesive. Instead of following a typical near linear cure over time (FIG. 2A), the cure rate of the present invention follows a sigmoidal (s-shaped) cure response. It is theorized that the MEKO silane is functioning to scavenge for moisture, thereby competing with the silane-modified urethane. Hydrolysis of the oxime silane can produce “n” moles of MEKO and 1 mole of a reactive substituted silanetriol. The silanetriols formed can further react with methoxy-substituted groups formed in earlier reactions. These early reactions are set under low moisture conditions in order to promote end-capping of urethane prepolymers and hydrosylated polyethers. The MEKO released can contribute to momentary plasticization of the adhesive mixture prior to its volatilization.

### Example 10

The following is a non-limiting example of producing an adhesive composition with magnetic properties. Components of the adhesive may be mixed under high speed dispersion, in an open tank configuration, etc.

In conjunction with any of the aforementioned examples, e.g., Examples 1-9, the method of producing the adhesive composition may further comprise adding and continuously blending 0.1-20% wt. iron to provide magnetic properties. For example, about 0.1-20% wt. ferrous oxide may be added to the mixture to provide magnetic properties. In another embodiment, about 10% wt. magnetite may be added to the mixture to provide magnetic properties. In yet another embodiment, about 3% wt. ferrite may be added to the mixture to provide magnetic properties. In other embodiments, about 5% wt. iron filings may be added to the mixture to provide magnetic properties.

### Example 11

The following is a non-limiting example of producing a “sleeping” adhesive composition for prolonged storage. Components of the adhesive may be mixed under high speed dispersion, in an open tank configuration, etc.

In conjunction with any of the aforementioned examples, the adhesive composition may be stored for a period of time until it is ready to be used for coating. This period of time may be at least 9 months, or at least 12 months. The shelf life of the adhesive may be stable for 12 months or more depending upon storage conditions. When it is time to use the adhesive and prior to applying a coating, about 0.01-1.5% wt. of an amine catalyst is added to the mixture to catalyze the curing process. The following is a non-limiting example of producing the sleeping adhesive composition.
1. Add about 40-45% wt. (by weight of total formulation) one or more urethane prepolymers.
2. Add and continuously blend about 20-26% wt. polyether polyol tackifier.
3. Add and continuously blend 1-2% wt. alkoxysilane.
4. Add and continuously blend 0.02-0.03% wt. aliphatic metal catalyst to catalyze the end-cap reaction.
5. Allow components to blend thoroughly (approximately 15-20 minutes).
6. Add and continuously blend 14.5% wt. mixture of aliphatic fatty acid ester (non-petroleum base) to disperse the urethane prepolymer and quench the urethane reaction.
7. Add and continuously blend 0.3% wt. vinyltrimethoxysilane to scavenge potential atmospheric humidity (from open tank configuration).
8. Add and continuously blend 9% wt. surface-treated natural calcium carbonate reinforcing extender to add body to the formulation and build viscosity.
9. Add and continuously blend 3% wt. surface treated fumed silicate to achieve “high viscosity with low shear, and low viscosity with high shear” appropriate for trowel application.
10. Add and continuously blend 1.5% wt. methyl ester of rosin, to plasticize the adhesive and/or reduce moisture sensitivity and/or enhance flexibility and adhesion to low energy flooring substrates.
11. Add and continuously blend 0.5% wt. pigment to achieve desired aesthetics.
12. Store the deactivated adhesive formulation until ready to use.
13. When ready to use the adhesive, add about 0.2-0.5% wt. amine catalyst to the deactivated adhesive formulation and blend.

In any of the aforementioned examples, the methods can include a step of adding and continuously blending a desired amount of carbon nanofibers to increase the electrical conductivity of the adhesive. Further still, the method may include a step of adding and continuously blending a desired amount of a static dissipative component to decrease the surface resistance of the adhesive. Thus, the adhesives of the present invention may acquire electrostatic dissipative properties.

### Example 12

The following is a non-limiting exemplary procedure for applying the MVS prepolymer composition on a concrete substrate.

For floor installation, all subfloors must be level, firm, dry, smooth and free of dust, dirt, wax, cut-back, paint, grease, oil, curing agents, mold, bond breakers, residual alkaline salts, densifiers, hardeners or any other foreign material that would inhibit bonding. Only mechanical or physical methods to clean the existing subfloor should be used. Sweeping compounds should not be used. The concrete needs to be cleaned with a light mop and honor all cracks. Depressions should be filled using waterproof cementitious compositions. To ensure porosity and provide a clean bonding surface it is recommended that the concrete surface be first ground to a concrete surface profile of CSP 1.

Before application of the MVS prepolymer composition, all dust should be vacuumed from the floor and the area lightly mopped. Using a broom applicator, it is recommended to spread at full strength. The blue product color will disappear upon cure. The MVS prepolymer composition will fluoresce under black light to ease application inspection. The appearance of damp concrete is an indicator of proper application. The creation of a heavy gloss sheet is an indicator of over application. Topical film or development of high gloss is useless and may require removal. If the surface requires a skim-coat, apply skim-coat after 2 hrs or when the composition is dry to the touch. Some surface tack is normal. The coverage will be uneven because concrete porosity is not uniform. Apply one coat, followed by a second “touch-up” 30 mins after the first application. Some overlap is unavoidable but acceptable. Penetration is critical, not film development. It is recommended to sand and vacuum any accidental heavy gloss patches before adhesive application. Surface tack is expected by design in order to provide a primed surface and to initiate inter-coat adhesion with flooring adhesives or cement patching materials. At least 90 mins should be allowed before application of any flooring adhesive. The MVS prepolymer composition, once applied, will penetrate the CSP-1 prepared concrete surface and reduce porosity by up to 80%. When using a MULTI type wet-set adhesive for sheet vinyl, care must be taken to allow sufficient flash.

### Example 13

TABLE 18 shows non-limiting embodiments of the MVS prepolymer composition of the present invention. Equivalents or substitutes are within the scope of the invention.

TABLE 18

| | FORMULA | | | |
|---|---|---|---|---|
| | A | B | C | D |
| COMPONENT | % vol | % vol | % vol | % vol |
| Polyisocyanate | 28-33 | 20-30 | 5-10 | 0 |
| Silyl-terminated polyether | 0 | 10-15 | 30-40 | 25-40 |
| p-chlorobenzotrifluoride | 45-52 | 40-50 | 45-55 | 40-50 |
| (PCBTF) | | | | |
| 1-Methoxy-2-Propyl | 9-13 | 10-15 | 10-12 | 8-15 |
| Acetate (MPA) | | | | |
| Methyl Ester of Rosin | 6-9 | 5-10 | 7-9 | 5-10 |
| Fluorcoarbon modified | 0.1-0.3 | 0.05-0.2 | 0.05-.2 | 0.05-0.3 |
| polymer | | | | |
| Dibutyltin dilaurate | 0.3-0.5 | 0.1-0.5 | 0.2-04 | 0.05-0.5 |
| Blue color | q.s | q.s | q.s | q.s. |

### Example 14

TABLE 19 shows exemplary chemical and physical properties of the MVS prepolymer composition.

TABLE 19

| | |
|---|---|
| Color: | Blue (clear upon application) |
| Solids: | Approx. 100% |
| Density: | 8.0 lbs/gal |
| Flammability: | non-flammable |
| VOC: | “0”, Zero |
| Single Coat Coverage: | 1,275 ft²/4.25 gal pail |
| Shelf Life: | One Year* |

*From date of manufacture and stored in original, sealed container

### Example 15

TABLE 20 shows exemplary results of the MVS prepolymer composition from an ASTM E-96—Water Vapor Transmission of Materials (Wet Cup Method) testing method. As a densifier and moisture suppressant, the MVS prepolymer composition was submitted for ASTM E-96 testing to evaluate the reduction in permeability for a given cementitious substrate. Samples were prepared with and without the prepolymer composition coating and the moisture vapor permeance of the treated and untreated cement board was recorded.

TABLE 20
ASTM E-96-Water Vapor Transmission of Materials (Perm)

| Samples | A | B | C | Ave |
|---|---|---|---|---|
| Untreated | 18.74 | 20.69 | 18.16 | 19.2 |
| MVS | 5.08 | 5.17 | 5.02 | 5.09 |

| | |
|---|---|
| Average Reduction | 74% |

### Example 16

TABLE 21 shows exemplary results of the MVS prepolymer composition from an ASTM F-1869—Measuring MVER of Concrete Subfloor Using Anhydrous Calcium Chloride testing method. To further substantiate the moisture vapor emission rate (MVER) reduction, a modified ASTM F-1869 test was conducted. Sample concrete slabs were prepared with and without the prepolymer composition coating and the MVER was recorded.

TABLE 21
ASTM F-1869-MVER Using
Anhydrous CaCl (lbs/100 sf/24 hr)

| Samples | A | B | C | D | E | F | Ave |
|---|---|---|---|---|---|---|---|
| Untreated | 10 | 11.2 | 10 | 7.6 | 7.6 | 7.4 | 9.0 |
| MVS | 3.2 | 3.5 | 3.7 | 2.6 | 2.7 | 2.7 | 3.1 |
| Ave. Reduction | 68 | 69 | 63 | 66 | 64 | 63 | 65.5% |

As used herein, the term “about” refers to plus or minus 10% of the referenced number. For example, an embodiment where a percent weight is about 50% includes a percent weight in a range of 45 and 55%. Furthermore, ratios and percentages are given as weights unless specified otherwise.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

What is claimed is:

1. A kit for preparing a waterproof adhesive, comprising:
a) a deactivated adhesive composition comprising:
i. a silane end-capped polymer;
ii. a reinforcing extender; and
iii. one or more thixotropic agents; and
b) a catalyst, wherein the catalyst is kept separate from the deactivated adhesive composition prior to use of the kit;
wherein to use the kit, the catalyst is mixed with the deactivated adhesive composition to produce the waterproof adhesive.

2. The kit of claim 1, wherein the deactivated adhesive composition is shelf stable for 12 months or longer.

3. The kit of claim 1, wherein the silane end-capped polymer comprises a silane end-capped polyurethane, a silane end-capped polyether, a silane-end capped polyol, a silane end-capped polyester, or a combination thereof.

4. The kit of claim 3, wherein the silane end-capped urethane comprises a flexible binder urethane, a slow-cure urethane, or both.

5. The kit of claim 1, wherein the deactivated adhesive composition comprises about 1-60 wt % of the silane end-capped polymer, about 20-40 wt % of the reinforcing extender, and about 2-6 wt % of the one or more thixotropic agents.

6. The kit of claim 1, wherein the catalyst is an amine catalyst.

7. The kit of claim 6, wherein an amount of the amine catalyst ranges from about 0.2-1.5 wt %.

8. The kit of claim 6, wherein the catalyst comprises bis(2-dimethylaminoethyl) ether, 1,8-diazabicyclo(5.4.0)undec-7-ene, tris[3-(dimethylamino)propyl]-hexahydro-s-triazine, tris(3-dimethylamino)propylamine, cyclohexyldiethanol-amine, diaminobicyclooctane, diisopropylethanolamine, ethanolamine, diethanolamine, dimethylaminopropylamine, dimethylethanolamine, dimethylcethylamine, dimethylhexadecylamine, dimethylcyclohexylamine, dimethyldodecylamine, triethylamine, triethylenediamine, triethanolamine, tetramethylethylenediamine, tetramethylhexamethylenediamine, pentamethyl-diethylenetriamine, 1 -(2-hydroxypropyl) imidazole, 1,2-dimethylimidazole, 2,2-dimorpholinodiethylether, methylmorpholine, ethylmorpholine, 4-[2-(dimethyl-amino)ethyl]-morpholine, 4-(2-methoxyethyl)-morpholine, 4-butyl-morpholine, 4-[2-(dimethylamino)ethyl]-morpholine, or 4-(2-aminopropyl)morpholine.

9. The kit of claim 1, wherein the reinforcing extender is hydrophobically modified.

10. The kit of claim 1, wherein the one or more thixotropic agents are hydrophobically modified.

11. The kit of claim 1, wherein the deactivated adhesive composition further comprises an anti-skinning agent.

12. The kit of claim 11, wherein the anti-skinning agent is a methylethylketoximino (MEKO) silane according to the formula: 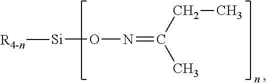
wherein n ranges from 1 to 4, wherein R is an alkyl, an alkene, or aryl group.

13. The kit of claim 1 wherein the composition further comprises a quenching agent, a tackifier, one or more moisture scavengers, a magnetic agent, a pigment, or a combination thereof.

14. A method of coating a substrate, said method comprising:
a) providing a waterproof adhesive coating kit according to claim 1;
b) prior to coating the substrate, adding the catalyst to the deactivated adhesive composition to form an activated adhesive; and
c) coating the substrate with the activated adhesive, wherein a cured coating of the activated adhesive is waterproof, hydrolytically stable, and pH-resistant.

15. A polymeric matrix adhesive composition, said composition comprising:
a) one or more prepolymers;
b) a functional silane;
c) a first catalyst;
d) a reinforcing extender;
e) one or more thixotropic agents; and
f) a second catalyst, wherein the second catalyst is different from the first catalyst;
wherein a cured product of the composition is waterproof, hydrolytically stable, and pH-resistant.

16. The composition of claim 15, wherein the composition further comprises an anti-skinning agent, a quenching agent, a tackifier, one or more moisture scavengers, a magnetic agent, a pigment, or a combination thereof.

17. The composition of claim 15, wherein the second catalyst is an amine catalyst.

18. A method of producing a waterproof adhesive, comprising:
a) preparing a deactivated adhesive composition comprising:
i. reacting one or more prepolymers, a functional silane, and a first catalyst to produce a silane end-capped polymer; and
ii. adding a reinforcing extender and one or more thixotropic agents to the silane end-capped polymer; and
b) adding a second catalyst to the deactivated adhesive composition, wherein the second catalyst is different from the first catalyst.

19. The method of claim 18, wherein the second catalyst is an amine catalyst.

20. The method of claim 18, wherein the second catalyst is kept separate from deactivated adhesive composition and only added to the deactivated adhesive composition immediately prior to using the waterproof adhesive.
